(19) United States
(12) Patent Application Publication
(10) Pub. No.: US 2023/0344553 A1
(43) Pub. Date: Oct. 26, 2023

(54) TECHNIQUES TO FACILITATE FREQUENCY/TIME GROUP BASED PHYSICAL UPLINK CHANNEL TRANSMISSION

(71) Applicant: QUALCOMM Incorporated, San Diego, CA (US)

(72) Inventors: Mohamad SAYED HASSAN, Paris (FR); Lianghai JI, San Diego, CA (US); Huilin XU, Temecula, CA (US); Jun MA, San Diego, CA (US); Liangping MA, San Diego, CA (US); Mehmet Izzet GURELLI, San Diego, CA (US); Karthik ANANTHA SWAMY, La Jolla, CA (US); Qiang WU, San Diego, CA (US); Weimin DUAN, San Diego, CA (US)

(21) Appl. No.: 17/660,188

(22) Filed: Apr. 21, 2022

(51) Int. Cl. H04L 1/08; H04W 72/12

(52) U.S. Cl. CPC H04L 1/08; H04W 72/1205

(57) ABSTRACT

A user equipment (UE) transmits a first message spanning a set of physical resource blocks (PRBs). The UE retransmits a first portion of the first message associated with a first subset of one or more PRBs in the set of PRBs, the set of PRBs grouped into a set of PRB bundles including a first subset of PRB bundles corresponding to the first subset of the one or more PRBs and skips retransmission of a second portion of the first message associated with a second subset of the PRB bundles of the set of PRB bundles, the second subset of the PRB bundles corresponding to at least a portion of remaining PRBs in the set of PRBs.

### INTRODUCTION

The present disclosure relates generally to communication systems, and more particularly, to wireless communications utilizing physical uplink channel transmissions.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication is provided. The method may include transmitting a first message spanning a set of physical resource blocks (PRBs). The example method may also include retransmitting a first portion of the first message associated with a first subset of one or more PRBs in the set of PRBs, the set of PRBs grouped into a set of PRB bundles including a first subset of PRB bundles corresponding to the first subset of the one or more PRBs. Additionally, the example method may include skipping retransmission of a second portion of the first message associated with a second subset of the PRB bundles of the set of PRB bundles, the second subset of the PRB bundles corresponding to at least a portion of remaining PRBs in the set of PRBs.

In another aspect of the disclosure, an apparatus for wireless communication is provided. The apparatus may include a memory and at least one processor coupled to the memory, the memory and the at least one processor configured to transmit a first message spanning a set of PRBs. The memory and the at least one processor may also be configured to retransmit a first portion of the first message associated with a first subset of one or more PRBs in the set of PRBs, the set of PRBs grouped into a set of PRB bundles including a first subset of PRB bundles corresponding to the first subset of the one or more PRBs. The memory and the at least one processor may also be configured to skip retransmission of a second portion of the first message associated with a second subset of the PRB bundles of the set of PRB bundles, the second subset of the PRB bundles corresponding to at least a portion of remaining PRBs in the set of PRBs.

In another aspect of the disclosure, an apparatus for wireless communication is provided. The apparatus may include means for transmitting a first message spanning a set of PRBs. The example apparatus may also include means for retransmitting a first portion of the first message associated with a first subset of one or more PRBs in the set of PRBs, the set of PRBs grouped into a set of PRB bundles including a first subset of PRB bundles corresponding to the first subset of the one or more PRBs. Additionally, the example apparatus may include means for skipping retransmission of a second portion of the first message associated with a second subset of the PRB bundles of the set of PRB bundles, the second subset of the PRB bundles corresponding to at least a portion of remaining PRBs in the set of PRBs.

In another aspect of the disclosure, a non-transitory computer-readable storage medium storing computer executable code for wireless communication is provided. The code, when executed, may cause a processor to transmit a first message spanning a set of PRBs. The example code, when executed, may also cause the processor to retransmit a first portion of the first message associated with a first subset of one or more PRBs in the set of PRBs, the set of PRBs grouped into a set of PRB bundles including a first subset of PRB bundles corresponding to the first subset of the one or more PRBs. The example code, when executed, may also cause the processor to skip retransmission of a second portion of the first message associated with a second subset of the PRB bundles of the set of PRB bundles, the second subset of the PRB bundles corresponding to at least a portion of remaining PRBs in the set of PRBs.

In an aspect of the disclosure, a method of wireless communication is provided. The method may include obtaining a first message spanning a set of PRBs in a first slot. The example method may also include obtaining a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

In another aspect of the disclosure, an apparatus for wireless communication is provided. The apparatus may include a memory and at least one processor coupled to the memory, the memory and the at least one processor configured to obtain a first message spanning a set of set of PRBs in a first slot. The memory and the at least one processor may also be configured to obtain a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

In another aspect of the disclosure, an apparatus for wireless communication is provided. The apparatus may include means for obtaining a first message spanning a set of PRBs in a first slot. The example apparatus may also include means for obtaining a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

In another aspect of the disclosure, a non-transitory computer-readable storage medium storing computer executable code for wireless communication is provided. The code, when executed, may cause a processor to obtain a first message spanning a set of set of PRBs in a first slot. The example code, when executed, may also cause the processor to obtain a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example environment that may support wireless communication including aspects of a terrestrial network, a satellite communication system, and an air-to-ground communication system, in accordance with various aspects of the present disclosure.

FIG. 5A illustrates an example of flat fading, in accordance with the teachings disclosed herein.

FIG. 5B illustrates an example of frequency-selective fading, in accordance with the teachings disclosed herein.

FIG. 6 illustrates an example environment in which a transmitter may transmit signals that are received by a receiver, in accordance with the teachings disclosed herein.

FIG. 7 illustrates an example diagram of a timeline illustrating example channel condition patterns across frequencies over time, in accordance with the teachings disclosed herein.

FIG. 8A illustrates an example diagram of a timeline illustrating example channel condition patterns across frequencies over time, in accordance with the teachings disclosed herein.

FIG. 8B illustrates an example diagram of a timeline illustrating another example of channel condition patterns across frequencies over time, in accordance with the teachings disclosed herein.

FIG. 8C illustrates an example diagram of a timeline illustrating another example of channel condition patterns across frequencies over time, in accordance with the teachings disclosed herein.

FIG. 8D illustrates an example diagram of a timeline illustrating another example of channel condition patterns across frequencies over time, in accordance with the teachings disclosed herein.

FIG. 9 illustrates an example flowchart of a method of wireless communication, in accordance with the teachings disclosed herein.

FIG. 10 illustrates an example communication flow between a base station and a UE, in accordance with the teachings disclosed herein.

FIG. 11 is a flow diagram illustrating example operations for resource mapping, in accordance with the teachings disclosed herein.

FIG. 12 illustrates an example communication flow between a base station and a UE, in accordance with the teachings disclosed herein.

FIG. 13 illustrating a diagram of retransmissions based on PRB-bundling, in accordance with the teachings disclosed herein.

FIG. 14 illustrates an example communication flow between a base station and a UE, in accordance with the teachings disclosed herein.

FIG. 15 illustrates an example communication flow between a base station and a UE, in accordance with the teachings disclosed herein.

FIG. 16 is a flowchart of a method of wireless communication at a UE, in accordance with the teachings disclosed herein.

FIG. 17 is a flowchart of a method of wireless communication at a UE, in accordance with the teachings disclosed herein.

FIG. 18 is a diagram illustrating an example of a hardware implementation for an example apparatus and/or wireless device.

FIG. 19A is a flowchart of a method of wireless communication at a network entity, in accordance with the teachings disclosed herein.

FIG. 19B is a flowchart of a method of wireless communication at a network entity, in accordance with the teachings disclosed herein.

FIG. 20 is a diagram illustrating an example of a hardware implementation for an example network entity.

FIG. 21A, FIG. 21B, and FIG. 21C illustrate example aspects of a network architecture that supports communication via an NTN device, in accordance with various aspects of the present disclosure.

### DETAILED DESCRIPTION

In wireless communications, a fading channel is a communication channel that experiences fading over time. Fading may refer to changes in a signal over the communication channel and may occur based on one or more aspects associated with a signal traveling through the communication channel, such as a propagation condition (e.g., line of sight (LOS) versus non-LOS (NLOS)), the path the signal takes, a medium through which the signal travels, weather, and/or obstructions. Fading may include large-scale fading and small-scale fading. Large-scale fading, such as path loss and shadowing effects, may occur when an object comes in-between a transmitter and a receiver and, thus, obstructs the wave propagation of the signal from the transmitter to the receiver. Small-scale fading may occur due to changes in the strength of the signal received at the receiver. An example of small-scale fading includes multipath delay spread, which includes flat fading and frequency-selective fading.

Multipath delay spread may occur when a signal travels two or more different paths before arriving at the receiver. For example, the signal may include a first frequency component and a second frequency component. The first frequency component of the signal may travel a direct path from the transmitter to the receiver. The second frequency component of the signal may travel an indirect path from the transmitter to the receiver. For example, the second frequency component may reflect off an object to the receiver. In such scenarios, the path associated with the second frequency component may be longer than the path associated with the first frequency component and result in an offset in gain and/or phase between the first frequency component and the second frequency component. Based on the characteristics of the first frequency component and the second frequency component, the frequency components may either constructively interfere (e.g., the received signal may appear stronger) or destructively interference (e.g., the received signal may appear weaker).

A wireless channel may be referred to as a flat fading channel if the wireless channel has constant gain and a linear phase response (e.g., proportionate changes in amplitude and/or phase) over a bandwidth that is greater than the bandwidth of the signal being transmitted by the transmitter. In such scenarios, the signal within the channel also experiences constant gain and a linear phase response. Additionally, the signal received by the receiver may experience proportional changes across the frequency components of the received signal. For example, a change in the amplitude of the first frequency component at a time T1 may be proportionate to a change in the amplitude of the second frequency component at the time T1.

A wireless channel may be referred to as a frequency-selective fading channel if different spectral components of a radio signal are affected with different amplitudes. That is, different frequency components of the signal may experience non-proportionate changes, sometimes referred to as “uncorrelated fading.” For example, a change in the amplitude of the first frequency component of the signal may be non-proportional to a change in the amplitude of the second frequency component of the signal.

With a flat fading channel, channel conditions over a group of physical resource blocks (PRBs) may be almost constant, or at least no deep-fading may be observed over a group of consecutive PRBs, as observed in a frequency-selective fading channel.

A wireless communication system may support data transmission with hybrid automatic repeat request (HARQ), for example, to improve reliability. For HARQ, a transmitter may send an initial transmission of a message and may send one or more additional transmissions of the message, if needed, until a termination event occurs, such as the message is decoded correctly by a receiver or a maximum quantity of transmissions of the message has occurred. After each transmission of the message, the receiver may send an acknowledgement (ACK) if the message is decoded correctly, or a negative ACK (NACK) if the message is decoded in error or missed. The transmitter may send another transmission of the message if a NACK is received and may terminate transmission of the message if an ACK is received. A message may also be referred to as a transport block, a packet, a codeword, a data block, etc.

In some examples, the transmitter may send the one or more transmissions of the message based on scheduling information. For example, a UE may receive an uplink grant scheduling the UE to transmit an uplink message, such as on a physical uplink shared channel (PUSCH). With HARQ, the receiver may store previously received messages. The receiver can use the stored messages for joint processing (e.g., combining) with the last received message (e.g., a current message) in order to enhance the decoding reliability. Examples of HARQ mechanisms include Chase combining HARQ and incremental redundancy (IR) HARQ.

For Chase combining HARQ, the transmitter repeats the same message at each retransmission. The receiver performs decoding (e.g., attempts to decode) a packet by combining all previously received messages. For example, the receiver may combine a current retransmitted message with an original message (e.g., a previously received and stored message) and where the retransmissions are identical copies of the original or initial transmission. That is, the retransmitted messages and the original message have a same redundancy version (RV).

For IR HARQ, the transmitter sends a message including new parity bits for each transmission. The receiver may store all of the previously received messages. For example, additional redundant information may be transmitted in each retransmission to increase a channel coding gain, where the retransmission consist of new parity bits. Different bits (e.g., new parity bits) can be transmitted by employing a different rate matching (puncturing) pattern, for example, which may result in a smaller effective code rate of a stream.

Performance-wise, IR HARQ may be similar to Chase combining HARQ when the coding rate is low, such as a low modulation and coding scheme (MCS). For example, a low MCS, such as MCS 0 may be associated with less puncturing and, thus, soft combining via Chase combining or IR may provide similar results. That is, with IR HARQ, the original transmission and a retransmission may be associated with different RV indices, but because there is less puncturing, e.g., at MCS 0, then the differences between the original transmission and the retransmission may be equivalent to the original transmission and the retransmission having a same RV index, as described in connection with Chase combining HARQ.

When employing HARQ, the transmitter may retransmit a message and/or transmit repetitions of the message based on the HARQ feedback. In such scenarios, the transmitter may be configured to retransmit the full message and/or each repetition of the message may include the full message. However, when the transmitter transmits the message in a flat fading channel, a first portion of the message may travel through a channel characterized as a good quality channel and a second portion of the message may travel through a channel characterized as a bad quality channel. In such examples, it may be a waste of resources to retransmit the full message and/or to transmit a repetition of the full message. For example, the first portion of the message may be successfully received by the receiver and, thus, additional retransmissions/repetitions of the first portion may use resources at the transmitter to transmit and at the receiver to receive and process.

Aspects disclosed herein provide techniques for using the characteristics associated with flat fading channels to improve aspects associated with retransmissions. In some examples, based on the channel conditions, an uplink message may include portions that are skipped or punctured in a retransmission or a repetition of the uplink message. In some examples, based on the channel conditions, portions of the uplink message may be transmitted a fewer quantity of times in retransmissions or repetitions compared to when the retransmission or repetition includes the full message. For example, when a channel is characterized as a good quality channel, the UE may puncture the portion of the uplink message associated with the good quality channel when retransmitting the uplink message. The term “puncture” and its variants may refer to removing information or skipping a portion of information when transmitting.

For example, the UE may remove the portion of the uplink message associated with the good quality channel when retransmitting the uplink message. When a channel is characterized as a bad quality channel, the UE may proceed to retransmit the portion of the uplink message associated with the bad quality channel. A network node may receive the initial transmission of the uplink message and determine channel conditions associated with the different channels. The network node may provide an indication of the channel conditions to the UE, which the UE may use to determine which portions of the uplink message to retransmit based on the respective channels. For example, the UE may generate the uplink message, but puncture the portion of the uplink message associated with a first sub-band and a second sub-band. Based on the good quality channel associated with the first sub-band and the second sub-band, the UE may presume that the portion of the uplink message carried on the first sub-band and the second sub-band are received by the network node. Thus, resources associated with good quality channels are not wasted when transmitting a retransmission of the uplink message based on the techniques disclosed herein. Instead, the resources may be allocated to the portion of the uplink message associated with bad quality channels.

In another example, aspects disclosed herein include techniques for improving retransmissions associated with a repetition factor. For example, disclosed techniques include providing repetition factors with PRB bundles. For example, before the network node provides an uplink grant with a repetition factor, the network node may estimate conditions for a set of channels. Based on the estimated channel conditions, the network node may determine a quantity of PRB bundles of one or more consecutive PRBs. The network node may then provide an uplink grant with an indication of a repetition factor for each PRB bundle.

The aspects presented herein may enable a UE to transmit retransmissions of a message using fewer uplink resources based on a lower PRB allocation, which may facilitate improving channel coding performance and/or spectral efficiency, for example, by increasing PRB power density. For example, the UE may be configured to transmit messages with a maximum power and the PRB power density may be based on a relationship between the maximum power and the quantity of PRBs associated with the message. By reducing the PRB allocation for the retransmission or repetition, the UE may increase the PRB power density based on the reduced quantity of PRBs associated with the retransmission or repetition.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

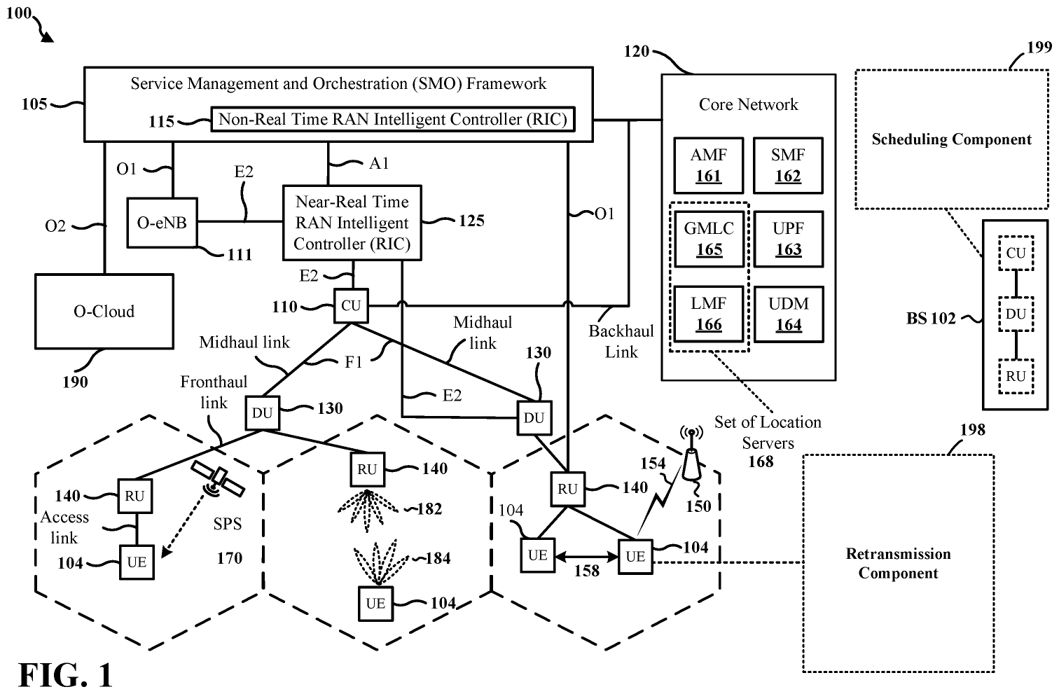

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., a UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., a RU 140) and the UEs (e.g., a UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between a UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as the UE 104, may be configured to manage one or more aspects of wireless communication. For example, the UE 104 may include a retransmission component 198 configured to perform PRB-bundle based physical uplink channel (PUCH) transmissions, such as physical uplink control channel (PUCCH) transmissions and/or physical uplink shared channel (PUSCH) transmissions. In certain aspects, the retransmission component 198 may be configured to transmit a first message spanning a set of PRBs. The example retransmission component 198 may also be configured to retransmit a first portion of the first message associated with a first subset of one or more PRBs in the set of PRBs, the set of PRBs grouped into a set of PRB bundles including a first subset of PRB bundles corresponding to the first subset of the one or more PRBs. Additionally, the example retransmission component 198 may be configured to skip retransmission of a second portion of the first message associated with a second subset of the PRB bundles of the set of PRB bundles, the second subset of the PRB bundles corresponding to at least a portion of remaining PRBs in the set of PRBs.

In another configuration, a base station, such as the base station 102, may be configured to manage or more aspects of wireless communication. For example, the base station 102 may include a scheduling component 199 configured to facilitate performing PRB-bundle based PUCH transmissions. In certain aspects, the scheduling component 199 may be configured to obtain a first message spanning a set of PRBs in a first slot. The scheduling component 199 may also be configured to obtain a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

The aspects presented herein may enable a UE to transmit retransmissions of a message using fewer uplink resources based on a lower PRB allocation, which may facilitate improving coverage, for example, by increasing PRB power density.

Although the following description provides examples directed to 5G NR, the concepts described herein may be applicable to other similar areas, such as LTE, LTE-A, CDMA, GSM, and/or other wireless technologies.

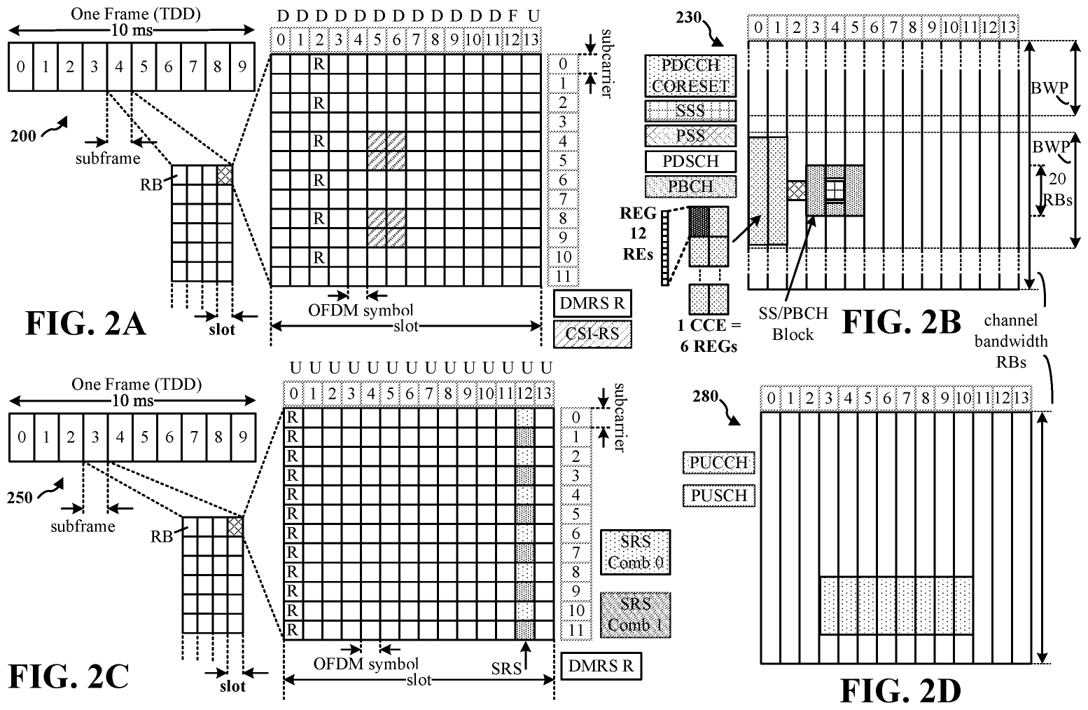

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

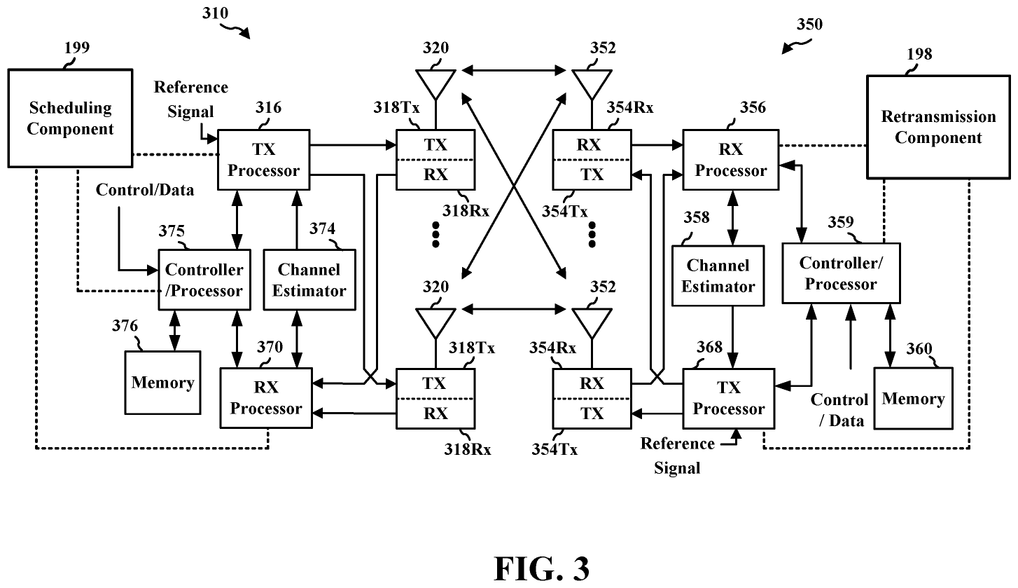

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the retransmission component 198 of FIG. 1.

At least one of the TX processor 316, the RX processor 370, and the controller/processor 375 may be configured to perform aspects in connection with the scheduling component 199 of FIG. 1.

To enable the transmission of communication from a mobile device (e.g., a mobile UE) at a location without terrestrial cellular network coverage, a number of approaches may be utilized. The communication may include any of various types of communication. In some aspects, the communication may be based on services associated with limited capabilities, such as a message. For example, the communication may include a short message service (SMS) message, an emergency message (e.g., an SOS message), a text message, a voice call, a public safety message, high priority communication, or other communication.

In one approach, the communication may be transmitted and delivered via a satellite communication (SatCom) system such as the Iridium system or another similar system. This approach may leverage the existing satellites that are already in operation, and may be associated with fast implementation and low deployment costs. However, there may be limited satellite coverage, and the communication may involve a specific type of UE that supports communication with the satellite. This approach may also be associated with strict antenna and TX power specifications. The operations may be human-assisted, where a skilled human may point the antenna toward the satellite to avoid blockage. Further, the approach may not be applicable to modern mobile devices with smaller form factors.

In another approach, the communication may be exchanged via a satellite-based non-terrestrial network (NTN), such as a 3GPP NTN. However, such NTNs may be associated with a high deployment cost to launch new satellites and install new gateways. In addition, it may be difficult for a smart phone device to autonomously connect to the NTN satellite due to the strict antenna and TX power specifications.

In another approach, the communication may be exchanged between a UE and a network via an aerial device. In some aspects, the aerial device may be provided at an aircraft. In some aspects, an aerial device may be provided via commercial aircraft to provide extended coverage for an area without a terrestrial network node. The air traffic provided by such aircraft may provide dense coverage, e.g., with aircraft within 50 km of each other. A typical cruising altitude may be on a scale of 10 kilometers (km) and may allow for line of sight (LOS) propagation to a device for over 200 km.

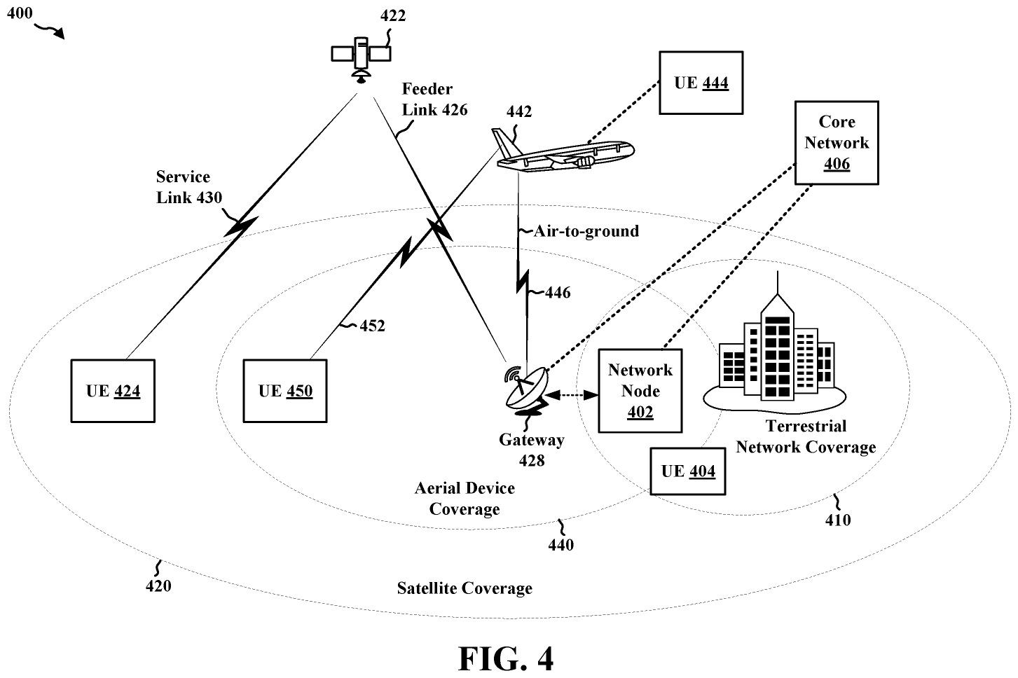

FIG. 4 is a diagram illustrating an example environment 400 that may support wireless communication including aspects of a terrestrial network, a satellite communication system, and an ATG communication system, as presented herein. To enable communication with a UE, a number of approaches may be utilized.

In some examples, a UE may communicate with a terrestrial network. In the illustrated example of FIG. 4, a terrestrial network includes a network node 402 that provides coverage to UEs, such as an example UE 404, located within a coverage area 410 for the terrestrial network. The network node 402 may facilitate communication between the UE 404 and a core network 406. Aspects of the core network 406 may be implemented by a core network, such as the example core network 120 of FIG. 1.

In some examples, a UE may transmit or receive satellite-based communication (e.g., via an Iridium-like satellite communication system or a satellite-based 3GPP NTN). For example, a satellite 422 may provide coverage to UEs, such as an example UE 424, located within a coverage area 420 for the satellite 422. In some examples, the satellite 422 may communicate with the core network 406 through a feeder link 426 established between the satellite 422 and a gateway 428 in order to provide service to the UE 424 within the coverage area 420 of the satellite 422 via a service link 430. The feeder link 426 may include a wireless link between the satellite 422 and the gateway 428. The service link 430 may include a wireless link between the satellite 422 and the UE 424. In some examples, the gateway 428 may communicate directly with the core network 406. In some examples, the gateway 428 may communicate with the core network 406 via the network node 402.

In some examples, an ATG communication system may facilitate in-flight communication for aircraft-borne UEs. For example, an aerial device 442 may provide coverage to aircraft-borne UEs, such as an example UE 444. The aerial device 442 may establish an ATG link 446 with the gateway 428 on the ground to provide service to the UE 444. For example, the aerial device 442 may provide on-board communication components, such as internal Wi-Fi antennas or other radio access technologies (RATs) to allow passengers to communicate with a terrestrial network based on ATG communication. The data traffic that may be carried over ATG communication systems may include aircraft passenger communications (e.g., communications associated with the passenger devices, which may be available en route, during takeoff, landing, climb, and/or descent), airline operation communications (e.g., aircraft maintenance information, flight planning information, weather information, etc.), and/or air traffic control communications (e.g., the ATG communication system may serve as a backup to systems operating in aviation licensed bands).

The aerial device 442 may relay a message from the UE 450 to the core network 406 and/or a message from the core network 406 to the UE 450. In the illustrated example of FIG. 4, the aerial device 442 may use an access link 452 to communicate with the UE 450. The aerial device 442 may use a standardized air interface (e.g., a 3GPP Uu interface) over the access link 452 to relay the message to and from the UE 450. The aerial device 442 may use the ATG link 446 to relay the message to and from the core network 406 (e.g., via the gateway 428). In some aspects, the ATG link 446 may be used to transport at least some protocol layers of a standardized air interface (e.g., a 3GPP Uu interface).

In some examples, a ground-based UE may be located within a coverage area of an aerial device, but outside the coverage area of a terrestrial network. For example, a UE 450 of FIG. 4 is located within a coverage area 440 of the aerial device 442, but may be located in a remote area and, thus, outside the coverage area 410 of the terrestrial network. In other examples, a connection between the UE 450 and the network node 402 may become blocked and, thus, the UE 450 may be unable to communicate with the network node 402 and the terrestrial network.

In wireless communications, a fading channel is a communication channel that experiences fading over time. Fading may refer to changes in a signal over the communication channel and may occur based on one or more aspects associated with a signal traveling through the communication channel, such as a propagation condition (e.g., LOS versus NLOS), the path the signal takes, a medium through which the signal travels, weather, and/or obstructions. Fading may include large-scale fading and small-scale fading. Large-scale fading, such as path loss and shadowing effects, may occur when an object comes in-between a transmitter and a receiver and, thus, obstructs the wave propagation of the signal from the transmitter to the receiver. Small-scale fading may occur due to changes in the strength of the signal received at the receiver. An example of small-scale fading includes multipath delay spread, which includes flat fading and frequency-selective fading.

Multipath delay spread may occur when a signal travels two or more different paths before arriving at the receiver. For example, the signal may include a first frequency component and a second frequency component. The first frequency component of the signal may travel a direct path from the transmitter to the receiver. The second frequency component of the signal may travel an indirect path from the transmitter to the receiver. For example, the second frequency component may reflect off an object to the receiver. In such scenarios, the path associated with the second frequency component may be longer than the path associated with the first frequency component and result in an offset in gain and/or phase between the first frequency component and the second frequency component. Based on the characteristics of the first frequency component and the second frequency component, the frequency components may either constructively interfere (e.g., the received signal may appear stronger) or destructively interference (e.g., the received signal may appear weaker).

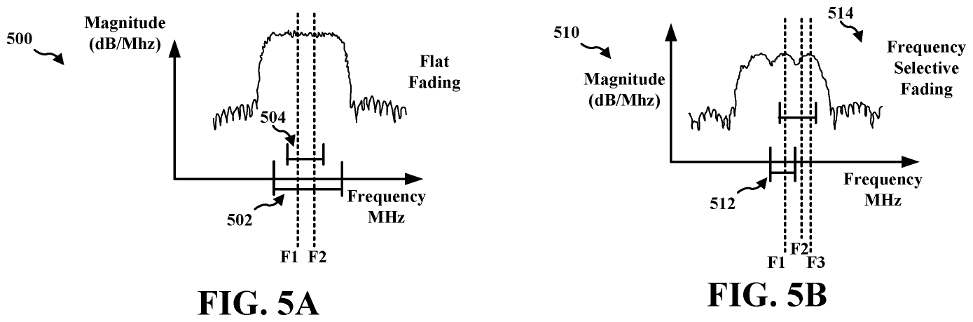

FIG. 5A illustrates an example 500 of flat fading, as presented herein. A wireless channel may be referred to as a flat fading channel if the wireless channel has constant gain and a linear phase response (e.g., proportionate changes in amplitude and/or phase) over a bandwidth that is greater than the bandwidth of the signal being transmitted by the transmitter. In the example of FIG. 5A, the channel has a channel bandwidth 502 and a signal has a signal bandwidth 504. As shown in FIG. 5A, the channel bandwidth 502 is larger than the signal bandwidth 504. In such scenarios, the signal within the channel also experiences constant gain and a linear phase response. For example, the change in magnitude within the channel bandwidth 502 is relatively constant and thus, the change in magnitude within the signal bandwidth 504 may also be relatively constant. Additionally, the signal may experience proportional changes across the frequency components of the signal. For example, the magnitude at a first frequency component (“F1”) of the signal may be proportionate to a magnitude at a second frequency component (“F2”) of the signa1502504.

FIG. 5B illustrates an example 510 of frequency-selective fading, as presented herein. A wireless channel may be referred to as a frequency-selective fading channel if different spectral components of a radio signal are affected with different amplitudes. That is, different frequency components of the signal may experience non-proportionate changes. In the example of FIG. 5B, the channel has a channel bandwidth 512 and a signal has a signal bandwidth 514. As shown in FIG. 5B, the signal bandwidth 514 is larger than the channel bandwidth 512. Different frequency components of the signal, therefore, experience non-proportionate fading (e.g., may experience different magnitudes). For example, a signal may include a first frequency component (“F1”), a second frequency component (“F2”), and a third frequency component (“F3”). In the example of FIG. 5B, the change in magnitude between the first frequency component and the second frequency component may be non-proportional to the change in magnitude between the second frequency component and the third frequency component.

In NTN scenarios and ATG scenarios, the delay spread associated with a signal is small as the signal is mainly communicated through LOS propagation. In an NTN scenario, a few clusters (e.g., up to three clusters) may be assumed. A cluster may refer to a group of rays sharing a common delay of arrival. For example, even with LOS propagation, it is possible for a signal to reflect off an object before reaching its intended target (e.g., a UE). The reflected signals may be referred to as rays and a cluster may refer to one or more rays that arrive at the intended target with a same delay of arrival (e.g., delay spread).

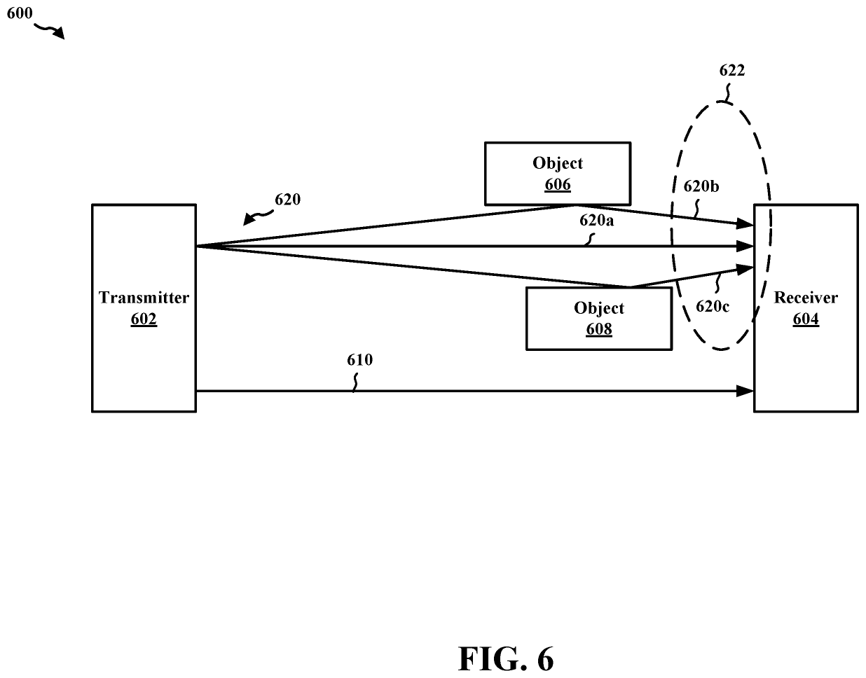

FIG. 6 illustrates an example environment 600 in which a transmitter 602 may transmit signals that are received by a receiver 604, as presented herein. In the example of FIG. 6, the transmitter 602 may transmit a first signal 610 that is received by the receiver 604. The first signal 610 is communicated through LOS propagation.

The transmitter 602 may transmit a second signal 620 that is received by the receiver 604. The second signal 620 may experience multipath propagation. For example, a first component 620a of the second signal 620 may travel a direct path from the transmitter 602 to the receiver 604. A second component 620b of the second signal 620 may reflect off of a first object 606 before being received at the receiver 604. A third component 620c of the second signal 620 may reflect off of a second object 608 before being received at the receiver 604. In the example of FIG. 6, the first component 620a, the second component 620b, and the third component 620c may arrive at the receiver 604 with a similar delay of arrival. In such scenarios, the first component 620a, the second component 620b, and the third component 620c may be referred to as a cluster 622.

In examples of wireless communications systems in which the delay spread is small (e.g., in NTN scenarios and ATG scenarios), the delay spread may be absorbed by a duration of a cyclic prefix added to a message. The cyclic prefix may be a repeated portion of the message to facilitate receiving the message. The cyclic prefix may ensure that the message retains its orthogonal properties in the presence of delay spread that may be caused by frequency-selective fading (e.g., a frequency response that is not flat).

With a flat fading channel, channel conditions over a group of physical resource blocks (PRBs) may be almost constant, or at least no deep-fading may be observed over a group of consecutive PRBs. For example, referring to the examples of FIGS. 5A and 5B, the signal bandwidth 504 and the signal bandwidth 514 may each be allocated a bandwidth associated with 30 PRBs. In the example of FIG. 5A, a group of consecutive PRBs of the 30 PRBs may be associated with same or similar channel conditions. In contrast, in the example of FIG. 5B, consecutive PRBs of the 30 PRBs may be associated with different channel conditions.

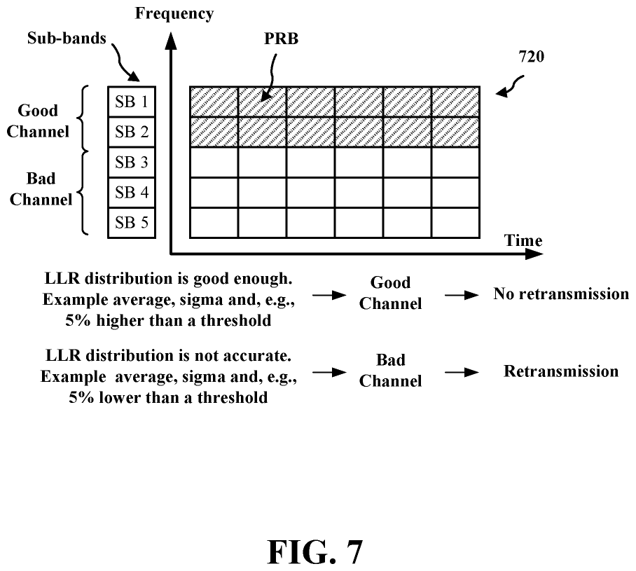

FIG. 7 illustrates an example diagram 720 of a timeline illustrating example channel condition patterns across frequencies over time, as presented herein. In the example of FIG. 7, a group of PRBs are allocated over six intervals in a time domain and across five sub-bands in a frequency domain. The six time intervals may be associated with one slot, may be associated with six different slots, or may be associated with a portion of a slot. Each block in the example of FIG. 7 may correspond to a PRB or to a PRB bundle including one or more PRBs associated with similar channel conditions.

In the example of FIG. 7, the channel is associated with flat fading and consecutive PRBs may be associated with similar channel conditions. For example, PRBs associated with a first sub-band (“SB 1”) and a second sub-band (“SB 2”) are associated with a first channel condition and PRBs associated with a third sub-band (“SB 3”), a fourth sub-band (“SB 4”), and a fifth sub-band (“SB 5”) are associated with a second channel condition. In the example of FIG. 7, the first channel condition corresponds to a “good” channel and the second channel condition corresponds to a “bad” condition.

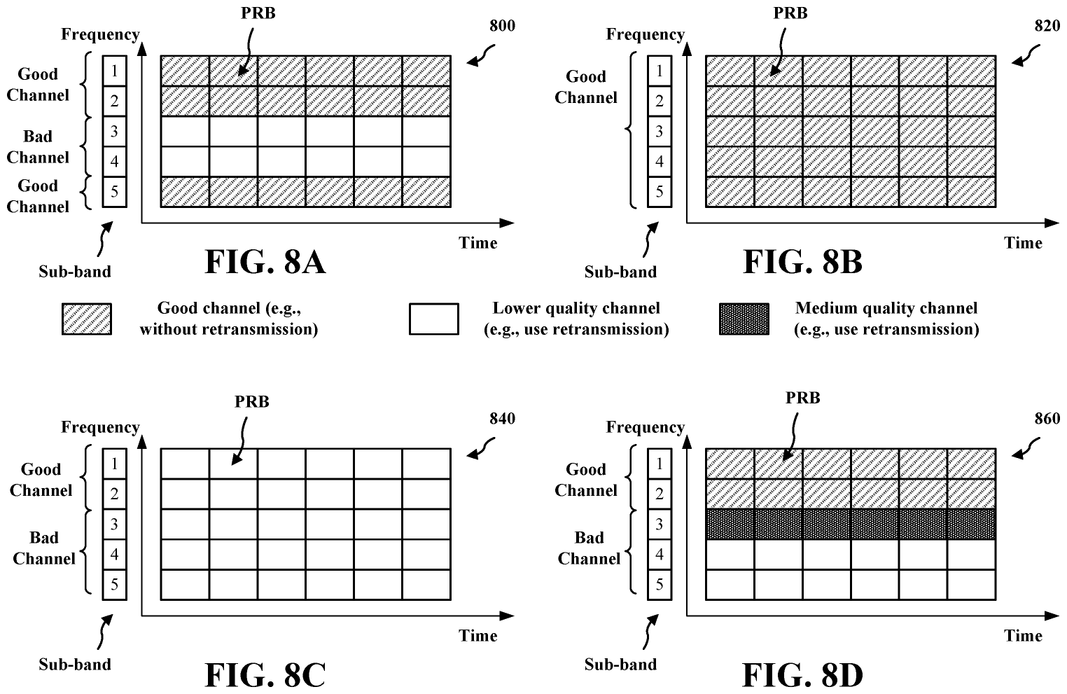

FIG. 8A, FIG. 8B, FIG. 8C, and FIG. 8D are diagrams of example timelines illustrating additional example channel condition patterns across frequencies and over time. For example, a channel may be characterized as having a first channel condition or a second channel condition. The first channel condition may correspond to a “good” channel and the second channel condition may correspond to a “lower quality” channel. Similar to the example of FIG. 7, the respective channels may be associated with flat fading and consecutive PRBs may be associated with similar channel conditions.

FIG. 8A illustrates an example diagram 800 of a timeline illustrating example channel condition patterns across frequencies over time, as presented herein. In the example of FIG. 8A, PRBs associated with a first sub-band (“SB 1”), a second sub-band (“SB 2”), and a fifth sub-band (“SB 5”) are associated with the first channel condition and PRBs associated with a third sub-band (“SB 3”) and a fourth sub-band (“SB 4”) are associated with the second channel condition.

FIG. 8B illustrates an example diagram 820 of a timeline illustrating another example of channel condition patterns across frequencies over time, as presented herein. In the example of FIG. 8B, PRBs associated with each of the five sub-bands are associated with the first channel condition.

FIG. 8C illustrates an example diagram 840 of a timeline illustrating another example of channel condition patterns across frequencies over time, as presented herein. In the example of FIG. 8C, PRBs associated with each of the five sub-bands are associated with the second channel condition.

FIG. 8D illustrates an example diagram 860 of a timeline illustrating another example of channel condition patterns across frequencies over time, as presented herein. In the example of FIG. 8D, PRB associated with a first sub-band (“SB 1”) and a second sub-band (“SB 2”) are associated with the first channel condition, PRBs associated with a third sub-band (“SB 3”) are associated with a third channel condition, and PRBs associated with a fourth sub-band (“SB 4”) and a fifth sub-band (“SB 5”) are associated with the second channel condition. In the example of FIG. 8D, the third channel condition may correspond to a “medium quality” channel. For example, the third channel condition may be better than the second channel condition, but not as good as the first channel condition.

The channel conditions may be characterized using different techniques. In one example technique, the channel conditions may be characterized based in part on log likelihood ratios (LLRs). For example, a receiver may receive a message over a wireless channel from a transmitter. The receiver may determine a set of intrinsic LLRs based at least in part on the message transmission. The receiver may determine an accumulated capacity of the channel based at least in part on the set of intrinsic LLRs. In some examples, the receiver may determine a channel quality indicator (CQI) based on the accumulated capacity.

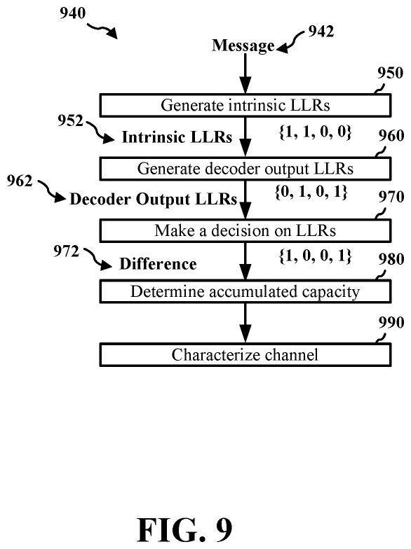

FIG. 9 illustrates an example flowchart 940 of a method of wireless communication, as presented herein. The method may be performed by a receiver device, such as a UE or a network entity. One or more aspects of the network entity may be performed by a component of a network entity or a base station, such as a CU, a DU, and/or an RU. The method may facilitate estimating channel conditions based on LLRs.

In the example of FIG. 9, the receiver receives a message 942. The message 942 may also be referred to as a transport block, a packet, a codeword, a data block etc. At 950, the receiver may generate intrinsic LLRs 952, sometimes referred to as a “soft bits.” The receiver may generate the intrinsic LLRs before the message 942 is decoded. At 960, the receiver may generate decoder output LLRs 962 that are determined after the message 942 is decoded.

An LLR may be a probability that a given bit is a 0 or a 1. A large positive LLR value indicates that the respective bit is believed to be a 1, while a large negative LLR value indicates that the respective bit is believed to be a 0. An LLR value of zero indicates that the respective bit has a 50/50 chance of being a 0 or a 1. That is, the receiver is unsure of whether the respective bit is a 0 or a 1. Before the message 942 is decoded, each bit of the message 942 may be predicted to be a 0 or a 1. The set of these predictions may be referred to as the intrinsic LLRs 952. The intrinsic LLRs 952 may be input to a decoder. The intrinsic LLRs 952 may be an array.

After the message 942 is decoded, the receiver may predict each bit of the decoded message to be a 0 or a 1. The set of these predictions may be referred to as the decoder output LLRs 962. The decoder output LLRs 962 may be hard-decisioned, and these bits may be the bits corresponding to the message 942. Since the decoder has a very low probability of error, it can be presumed that any errors in the decoded message may be attributed to errors caused by the wireless channel, e.g., due to poor conditions. The wireless channel may be poor due to interference, multi-path propagation, weather conditions, or the like. Hard decision decoding may take a stream of LLRs or a block of LLRs from a receiver and decode each bit by considering it as definitely a 1 or a 0.

At 970, the receiver makes a decision on LLRs of the message 942, e.g., the intrinsic LLRs 952 and the decoder output LLRs 962. In one example, the receiver may subtract the intrinsic LLRs 952 from the decoder output LLRs 962 to generate a difference 972. Any bit greater than 0 may indicate an error. The difference 972 may represent an error caused by the wireless channel.

As an illustration, consider an example in which the message 942 is a 4-bit message. The receiver may generate, at 950, the intrinsic LLRs 952 including a set {1, 1, 0, 0}. The receiver may input the intrinsic LLRs 952 and/or the message 942 to a decoder to generate hard-decisioned bits. For example, the receiver, at 960, may generate decoder output LLRs 962 including a set {0, 1, 0, 1}. At 970, the receiver may make a decision on the LLRs based on a different or an exclusive-OR (XOR) between the intrinsic LLRs 952 and the decoder output LLRs 962. In this example, the decision may generate the difference 972 including a set {1, 0, 0, 1}. In this example, two of the bits have a difference value that is greater than 0 (e.g., the first bit and the fourth bit), indicating that there are two bits in error. Because the rate of error at a decoder is small, the two bits in error may be attributed to error caused by the wireless channel.

At 980, the receiver may determine an accumulated capacity, or a spectral efficiency, of a channel. The receiver may determine the accumulated capacity based on a signal-to-noise ratio (SNR) and/or a signal to interference and noise ratio (SINR) associated with the channel. The SNR and/or the SINR may be determined based in part on the difference 972 between the intrinsic LLRs 952 and the decoder output LLRs 962.

At 990, the receiver may characterize the channel. The receiver may characterize the channel based on the accumulated capacity of the channel. For example, the receiver may compare the accumulated capacity of the channel to a threshold capacity. The receiver may characterize the channel with the first channel condition when the accumulated capacity satisfies the threshold capacity, and may characterize the channel with the second channel condition when the accumulated capacity fails to satisfy the threshold quality.

In some examples, satisfying the threshold capacity may include the accumulated capacity of the channel being greater than the threshold capacity or the accumulated capacity of the channel being greater than or equal to the threshold capacity. In some examples, satisfying the threshold capacity may include the accumulated capacity of the channel being less than the threshold capacity or the accumulated capacity of the channel being less than or equal to the threshold capacity.

Referring again to the example of FIG. 7, a channel may be characterized as having good channel conditions based on the LLR distribution, as discussed in connection with 990 of FIG. 9. In some examples, a “good” LLR distribution indicates that the bit error rate is low and that the intrinsic LLRs (e.g., the intrinsic LLRs 952) are similar to the decoder output LLRs (e.g., the decoder output LLRs 962 of FIG. 9). Other example techniques of determining that the LLR distribution is “good” may be based on an average or a sigma. For example, the LLR distribution may be “good” when the average LLR distribution satisfies an average threshold (e.g., the LLR distribution is higher than the average threshold). In contrast, an LLR distribution may be determined to be “not accurate” when the average LLR distribution fails to satisfy the average threshold (e.g., the LLR distribution is less than the average threshold). In another example, the LLR distribution may be “good” when the lowest 5% in a cumulative distribution function (CDF) of the LLR distributions satisfies a CDF threshold (e.g., the LLR distribution is higher than the CDF threshold). In contrast, the LLR distribution may be determined to be “not accurate” when the lowest 5% in the CDF of the LLR distribution fails to satisfy the CDF threshold (e.g., the LLR distribution is less than the CDF threshold). In another example, the LLR distribution may be “good” when a sigma of the LLR distribution satisfies a sigma threshold (e.g., the LLR distribution is higher than the sigma threshold). In contrast, the LLR distribution may be determined to be “not accurate” when the sigma of the LLR distribution fails to satisfy the sigma threshold (e.g., the LLR distribution is less than the sigma threshold). In some examples, the determination of whether an LLR distribution is “good” or “not accurate” may be based on a combination of metrics, such as one or more of an average threshold, a CDF threshold, and/or a sigma threshold.

It may be appreciated that the example techniques for determining a “good” LLR distribution or a “not accurate” LLR distribution based on an average threshold, a CDF threshold, and/or a sigma threshold are merely illustrative and that other examples may employ additional or alternative techniques for characterizing a channel. For example, in another example, a determination of whether an LLR distribution is “good” or “not accurate” may be based on one or more metrics derived from the LLR distribution.

In some examples, as described in connection with the example of FIG. 8D, the channel may be characterized into tiers, such as a good quality channel, a lower quality channel, and a medium quality channel. In such examples, the LLR distribution may be compared to two thresholds to determine whether to characterize the channel as good quality, lower quality, or medium quality. Although the example of FIG. 8D includes three tiers of channel qualities, other examples may include any suitable quantity of tiers, such as two tiers (e.g., as shown in the examples of FIG. 7, FIG. 8A, FIG. 8B, and FIG. 8C), four tiers, five tiers, etc.

It may be appreciated that the likelihood of a message being received at a receiver may be negatively impacted when the channel through which the message is transmitted is of a “bad” channel or a “lower quality” channel. A wireless communication system may support data transmission with HARQ, for example, to improve reliability. For HARQ, a transmitter may send an initial transmission of a message and may send one or more additional transmissions of the message, if needed, until a termination event occurs, such as the message is decoded correctly by a receiver or a maximum quantity of transmissions of the message has occurred. After each transmission of the message, the receiver may send an ACK if the message is decoded correctly, or a NACK if the message is decoded in error or missed. The transmitter may send another transmission of the message if a NACK is received and may terminate transmission of the message if an ACK is received. A message may also be referred to as a transport block, a packet, a codeword, a data block, etc.

In some examples, the transmitter may send the one or more transmissions of the message based on scheduling information. For example, a UE may receive an uplink grant scheduling the UE to transmit an uplink message, such as on a PUSCH. With HARQ, the receiver may store previously received messages. The receiver can use the stored messages for joint processing (e.g., combining) with the last received message (e.g., a current message) in order to enhance the decoding reliability. Examples of HARQ mechanisms include Chase combining HARQ and incremental redundancy (IR) HARQ.

For Chase combining HARQ, the transmitter repeats the same message at each retransmission. The receiver performs decoding (e.g., attempts to decode) a packet by combining all previously received messages. For example, the receiver may combine a current retransmitted message with an original message (e.g., a previously received and stored message) and where the retransmissions are identical copies of the original or initial transmission. That is, the retransmitted messages and the original message have a same redundancy version (RV).

For IR HARQ, the transmitter sends a message including new parity bits for each transmission. The receiver may store all of the previously received messages. For example, additional redundant information may be transmitted in each retransmission to increase a channel coding gain, where the retransmission consist of new parity bits. Different bits (e.g., new parity bits) can be transmitted by employing a different rate matching (puncturing) pattern, for example, which may result in a smaller effective code rate of a stream.

Performance-wise, IR HARQ may be similar to Chase combining HARQ when the coding rate is low, such as a low modulation and coding scheme (MCS). For example, a low MCS, such as MCS 0 may be associated with less puncturing and, thus, soft combining via Chase combining or IR may provide similar results. That is, with IR HARQ, the original transmission and a retransmission may be associated with different RV indices, but because there is less puncturing, e.g., at MCS 0, then the differences between the original transmission and the retransmission may be equivalent to the original transmission and the retransmission having a same RV index, as described in connection with Chase combining HARQ.

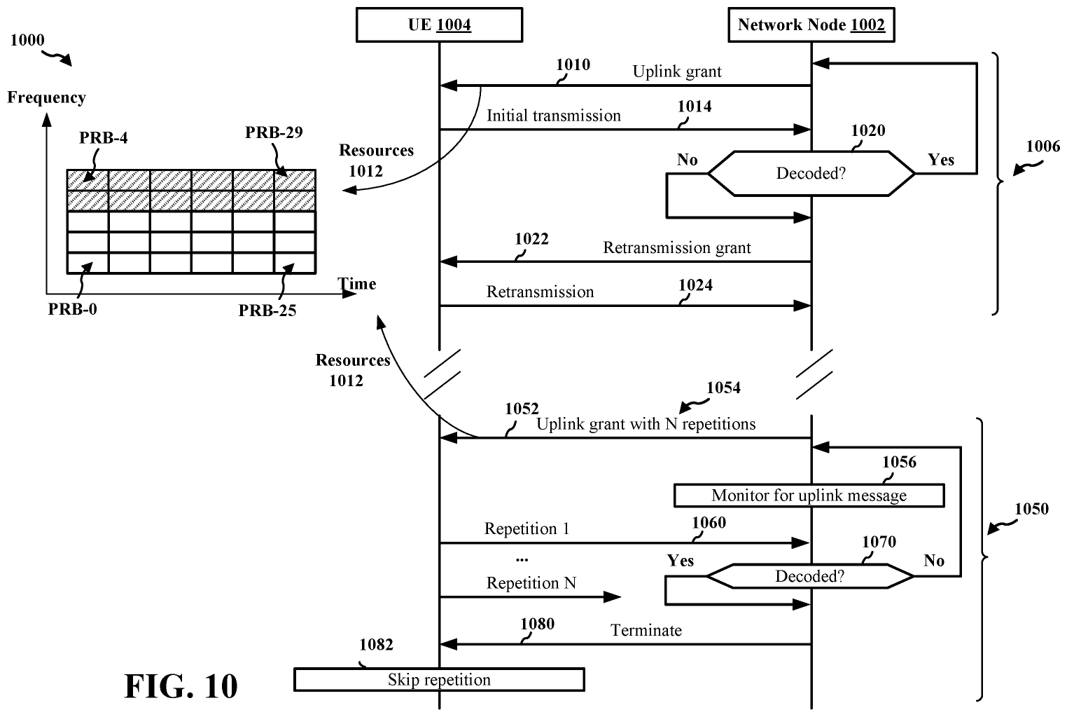

FIG. 10 illustrates an example communication flow 1000 between a network node 1002 and a UE 1004, as presented herein. One or more aspects described for the network node 1002 may be performed by a component of a base station or a network entity, such as a CU, a DU, and/or an RU. In the illustrated example, the communication flow 1000 facilitates the UE 1004 performing retransmissions. Aspects of the network node 1002 may be implemented by the base station 102 of FIG. 1 and/or the base station 310 of FIG. 3. Aspects of the UE 1004 may be implemented by the UE 104 of FIG. 1 and/or the UE 350 of FIG. 3. Although not shown in the illustrated example of FIG. 10, in additional or alternative examples, the network node 1002 may be in communication with one or more other base stations or UEs, and/or the UE 1004 may be in communication with one or more other base stations or UEs.

In some examples, retransmission may be performed via control information. For example, FIG. 10 illustrates a first retransmission procedure 1006 that is based in part on DCI. In the illustrated example of FIG. 10, the network node 1002 transmits an uplink grant 1010 that is received by the UE 1004. The network node 1002 may transmit the uplink grant 1010 on a physical downlink control channel (PDCCH). The uplink grant 1010 may include information related to an uplink message, such as an indication of resources 1012 (e.g., frequency resources and/or time resources) allocated for transmitting the uplink message. In the illustrated example of FIG. 10, the resources 1012 are associated with 30 PRBs ranging from PRB-0 to PRB-29.

As shown in FIG. 10, the UE 1004 transmits an initial transmission 1014 of the uplink message. The UE 1004 may transmit the initial transmission 1014 on a physical uplink control channel (PUCCH) or on a physical uplink shared channel (PUSCH). In the example of FIG. 10, the UE 1004 transmits the initial transmission 1014 on the resources 1012 associated with the PRB ranging from PRB-0 to PRB-29.

At 1020, the network node 1002 determines whether the uplink message of the initial transmission 1014 is decoded. If the network node 1002 determines that the uplink message of the initial transmission 1014 is successfully decoded, then control may return and the network node 1002 may transmit an uplink grant 1010 associated with a new uplink message.

If, at 1020, the network node 1002 determines that decoding the uplink message of the initial transmission 1014 is unsuccessful, then the network node 1002 may transmit a retransmission grant 1022. The network node 1002 may transmit the retransmission grant 1022 using downlink control information (DCI) on a PDCCH. The retransmission grant 1022 may include a NACK indicating that decoding the uplink message of the initial transmission 1014 was unsuccessful. The retransmission grant 1022 may also include an indication of resources for transmitting a retransmission 1024 of the uplink message. The resources indicated in the retransmission grant 1022 may be the same as the resources 1012 indicated in the uplink grant 1010.

As shown in FIG. 10, the UE 1004 transmits a retransmission 1024 of the uplink message. The UE 1004 may transmit the retransmission 1024 on PUCCH or PUSCH. The UE 1004 may use the resources indicated in the uplink grant 1010 and/or the resources indicated in the retransmission grant 1022 to transmit the uplink message on the retransmission 1024.

As shown in FIG. 10, the first retransmission procedure 1006 provides a retransmission technique in which retransmissions may be eliminated or reduced for scenarios in which the network node 1002 decodes the uplink message of the initial transmission 1014. However, there is downlink overhead associated with each retransmission. For example, the network node 1002 transmits a retransmission grant for each retransmission 1024 of the uplink message.

The illustrated example of FIG. 10 also includes a second retransmission procedure 1050 that is based on repetitions. In the illustrated example of FIG. 10, the network node 1002 transmits an uplink grant 1052 that is received by the UE 1004. The network node 1002 may transmit the uplink grant 1052 on a physical downlink control channel (PDCCH). The uplink grant 1052 may include information related to an uplink message, such as an indication of the resources 1012 (e.g., frequency resources and/or time resources) allocated for transmitting the uplink message. The uplink grant 1052 may also include a repetition factor 1054 indicating a quantity of repetitions of the uplink message. For example, based on the uplink grant 1052, the UE 1004 may determine to transmit N repetitions of the uplink message, may determine a first resource allocated to an initial transmission of the uplink message, and may determine subsequent resources allocated for the N−1 repetitions of the uplink message. The UE 1004 may transmit up to N repetitions of the uplink message until a termination event occurs, as described above.

At 1056, the network node 1002 monitors for the uplink message. For example, the network node 1002 may monitor the resources 1012 allocated to the UE 1004 for transmitting the uplink message via the uplink grant 1052. The network node 1002 may monitor the resources associated with receiving any of the N repetitions of the uplink message.

As shown in FIG. 10, the UE 1004 may transmit one or more repetitions of the uplink message (e.g., up to N repetitions). A first repetition 1060 (“Repetition 1”) of the uplink message may correspond to an initial transmission or an original transmission of the uplink message, such as the initial transmission 1014 of the first retransmission procedure 1006. The UE 1004 may transmit the first repetition 1060 on a PUCCH or on a PUSCH. In the example of FIG. 10, the UE 1004 transmits the initial transmission 1014 on the resources 1012 associated with the PRB ranging from PRB-0 to PRB-29.

The UE 1004 may continue transmitting the repetitions to the network node 1002 until a termination event occurs. For example, the UE 1004 may stop transmitting repetitions after transmitting the N repetitions. In another example, the UE 1004 may stop transmitting repetitions after a timer associated with repetitions expires. In another example, the UE 1004 may stop transmitting repetitions after an indication of a successfully decoded uplink message is received.

For example, at 1070, the network node 1002 may determine whether the uplink message of the first repetition 1060 is decoded. If the network node 1002 determines that the uplink message is successfully decoded and the current repetition is less than the N repetitions, then control may proceed and the network node may transmit a terminate message 1080 that is received by the UE 1004. The terminate message 1080 may include an ACK indicator indicating the uplink message associated with the uplink grant 1052 is successfully received. At 1082, the UE 1004 may skip transmitting subsequent repetitions of the uplink message based on the terminate message 1080.

If, at 1070, the network node 1002 determines that decoding the uplink message of the first repetition 1060 is unsuccessful, then control may return at 1056 and the network node 1002 may resume monitoring for subsequent repetitions of the uplink message.

As shown in FIG. 10, the second retransmission procedure 1050 provides a retransmission technique in which overhead associated with downlink signaling may be reduced. For example, the network node 1002 may avoid transmitting grants for each repetition of the uplink message. However, the repetition factor 1054 is associated with the uplink grant 1052 and the corresponding uplink message.

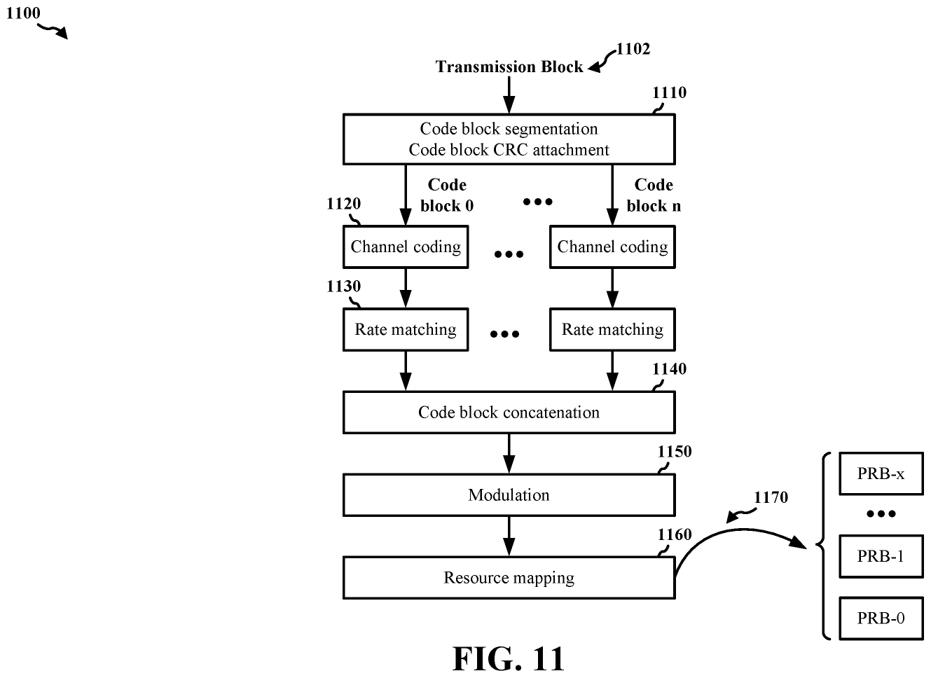

FIG. 11 is a flow diagram 1100 illustrating example operations for resource mapping, as presented herein. A transmission block may be segmented into multiple code blocks. As shown in FIG. 11, a transmission block 1102 may be segmented, at 1110, into several code blocks. The smaller code blocks may reduce decoding complexity at the receiver and may enable early termination with cyclic redundancy check (CRC) for each code block. After channel coding, at 1120, and rate matching, at 1130, for each code block, data may be concatenated (e.g., at 1140), modulated (e.g., at 1150), and mapped into a resource grid (e.g., at 1160), similar to the resource grid illustrated in the examples of FIGS. 2A to 2D. In the example of FIG. 11, the code blocks are mapped into a PRB set 1170 including PRB-0 to PRB-x. Each PRB of the PRB set 1170 may include a respective portion of information of the transmission block 1102. For example, the information of the transmission block 1102 may be split into x portions and each of the x portions may be mapped onto a respective PRB of the PRB set 1170 (e.g., a first portion of the transmission block 1102 may be mapped to the PRB-0, a second portion of the transmission block 1102 may be mapped to a PRB-1, . . . , an x-th portion of the transmission block 1102 may be mapped to the PRB-x).

When employing HARQ, the transmitter may retransmit a message and/or transmit repetitions of the message based on the HARQ feedback. In such scenarios, the transmitter may be configured to retransmit the full message and/or each repetition of the message may include the full message. However, when the transmitter transmits the message in a flat fading channel, a first portion of the message may travel through a channel characterized as a good quality channel and a second portion of the message may travel through a channel characterized as a bad quality channel. In such examples, it may be a waste of resources to retransmit the full message and/or to transmit a repetition of the full message. For example, the first portion of the message may be successfully received by the receiver and, thus, additional retransmissions/repetitions of the first portion may use resources at the transmitter to transmit and at the receiver to receive and process.

Aspects disclosed herein provide techniques for using the characteristics associated with flat fading channels to improve aspects associated with retransmissions. In some examples, based on the channel conditions, an uplink message may include portions that are skipped or punctured in a retransmission or a repetition of the uplink message. In some examples, based on the channel conditions, portions of the uplink message may be transmitted a fewer quantity of times in retransmissions or repetitions compared to when the retransmission or repetition includes the full message. For example, when a channel is characterized as a good quality channel, the UE may puncture the portion of the uplink message associated with the good quality channel when retransmitting the uplink message. When a channel is characterized as a bad quality channel, the UE may proceed to retransmit the portion of the uplink message associated with the bad quality channel. For example, and referring to the example of FIG. 7, a UE may transmit an initial transmission of an uplink message based on the 30 PRBs. A network node may receive the initial transmission of the uplink message and determine channel conditions associated with the different channels. In the example of FIG. 7, the first sub-band and the second sub-band are associated with good quality channels and the remaining sub-bands as associated with bad quality channels. The network node may provide an indication of the channel conditions to the UE, which the UE may use to determine which portions of the uplink message to retransmit based on the respective channels. For example, the UE may transmit the uplink message, but puncture the portion of the uplink message associated with the first sub-band and the second sub-band. Based on the good quality channel associated with the first sub-band and the second sub-band, the UE may presume that the portion of the uplink message carried on the first sub-band and the second sub-band are received by the network node. Thus, and with respect to the first retransmission procedure 1006 of FIG. 10, resources associated with good quality channels are not wasted when transmitting a retransmission of the uplink message. Instead, the resources may be allocated to the portion of the uplink message associated with bad quality channels.

For example, a coverage UE (e.g., a UE at a cell edge) may be configured to transmit uplink messages on resources associated with ten PRBs and with a maximum power (Pₘₐₓ) of 23 dBm. In such an example, the UE may transmit each PRB with a power with respect to the initial transmission and any subsequent retransmissions. The power may be determined based on Equation 1 (below).

Pₙ=Pₘₐₓ−10 log₁₀(n) Equation 1:

In Equation 1, the term “Pₘₐₓ” represents the maximum power, the term “n” represents the quantity of PRBs in the transmission, and the term “Pₙ” represents the power of each PRB in the transmission based on the maximum power and the quantity of PRBs. For example, based on Equation 1, a maximum power of 23 dBm, and resources associated with the PRBs, the coverage UE may transmit each PRB with a first power density indicated by Equation 2 (below).

P₁₀=23−10 log₁₀(10) Equation 2:

However, using the techniques disclosed herein, the UE may transmit the initial transmission with the first power density (P₁₀) with respect to each PRB. The UE may then receive an indication that a first five PRBs are associated with good quality channels and that a second five PRBs are associated with bad quality channels. In such a scenario, the UE may retransmit the portion of the uplink message associated with the second five PRBs and puncture the portion of the uplink message associated with the first five PRBs. Additionally, by skipping the portion of the uplink message associated with the good quality channels, the UE has the ability to increase the power density for each PRB in the retransmission as the UE splits the max power over five PRBs instead of the ten PRBs. For example, the UE may transmit the retransmission with a power density that is greater than the power density associated with the initial transmission. For example, the UE may transmit the five PRBs of the retransmission with a second power density indicated by Equation 3 (below).

P₅=23−10 log₁₀(5) Equation 3:

Based on the second power density, indicated by Equation 3, and the first power density, indicated by Equation 2, the UE may transmit each PRB of the retransmission with a higher power density compared to each PRB of the initial transmission.

As another example, and with respect to the example of FIG. 11, a UE may be allocated the PRB set 1170 to transmit an uplink message associated with the transmission block 1102. The PRB set 1170 may include two PRBs and a first portion of the transmission block 1102 may be mapped to the PRB-0 and a second portion of the transmission block 1102 may be mapped to the PRB-1. Based on channel conditions associated with each of the PRBs of the PRB set 1170, the network node may determine to group the PRBs into PRB bundles of one PRB each and indicate which PRB bundles are associated with good quality channels (e.g., a first PRB bundle including the PRB-0) and bad quality channels (e.g., a second PRB bundle including the PRB-1). The UE may use the indications provided by the network node to output a retransmission of the uplink message in which the retransmission includes the portion of the transmission block 1102 associated with the bad quality channels (e.g., the second portion of the transmission block 1102 associated with the second PRB bundle including the PRB-1). In some examples, the portions of the transmission block 1102 may correspond to the code blocks at 1110 of FIG. 11. In other examples, the portions of the transmission block 1102 may correspond to different segmentations of the transmission block 1102.

In another example, aspects disclosed herein include techniques for improving retransmissions associated with a repetition factor, such as the example second retransmission procedure 1050 of FIG. 10. For example, disclosed techniques include providing repetition factors with PRB bundles. For example, before the network node provides an uplink grant with a repetition factor, such as the example uplink grant 1052 of FIG. 10, the network node may estimate conditions for a set of channels. Based on the estimated channel conditions, the network node may determine a quantity of PRB bundles of one or more consecutive PRBs. The network node may then provide an uplink grant with an indication of a repetition factor for each PRB bundle.

For example, the network node may receive a reference signal and estimate channel conditions for different channels based on the reference signal. The reference signal may include a sounding reference signal (SRS) or another uplink reference signal that may be used for sounding. Based on the estimated channel conditions, the network node may determine a PRB bundle granularity indicating a quantity of PRBs associated with each PRB. The network node may provide the PRB bundle granularity and a repetition factor associated with each PRB bundle to the UE. The UE may then transmit the portion of the uplink message associated with each PRB bundle based on the respective repetition factor. For example, and referring to the example of FIG. 7, the network node may group the PRBs into five PRB bundles, where each PRB bundle is associated with a different sub-band. In such an example, the PRB bundle granularity may indicate that there are six PRBs included in each PRB and the network node may provide five repetition factors corresponding to the five PRB bundles.

After receiving the uplink grant, the UE may determine that there are 30 PRBs allocated to an uplink message and based on the PRB bundle granularity, the UE may determine that there are five PRB bundles. The UE may then transit each portion of the uplink message based on the repetition factor associated with the respective PRB bundle. For example, the UE may transmit the portions of the uplink message carried on the first sub-band and the second sub-band one time based on the indication that the respective sub-bands are good quality channels. The UE may transmit the portions of the uplink message carried on the third sub-band, the fourth sub-band, and the fifth sub-band a plurality of times based on the indication that the respective sub-bands are bad quality channels.

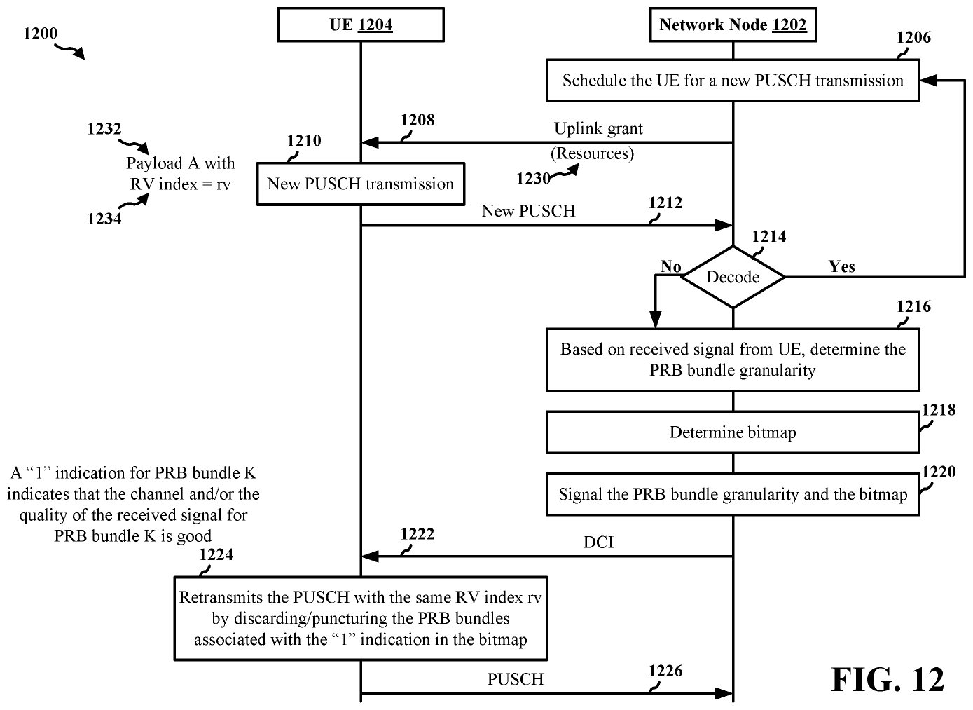

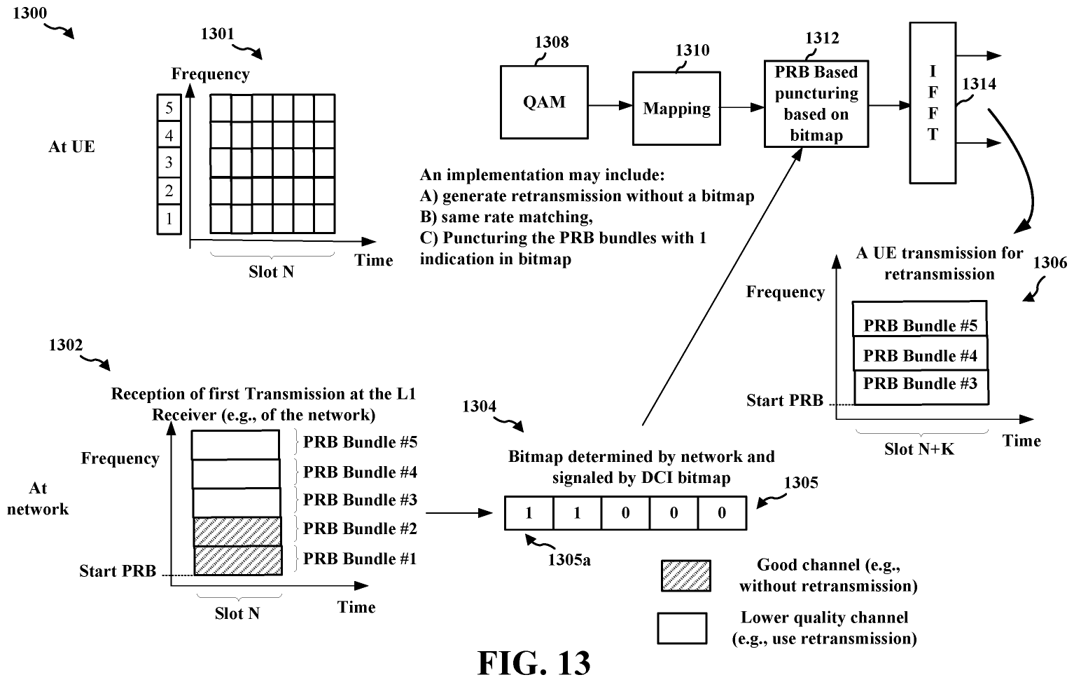

FIG. 12 illustrates an example communication flow 1200 between a network node 1202 and a UE 1204, as presented herein. Aspects of the communication flow 1200 may be described in connection with FIG. 13 illustrating a diagram of retransmissions based on PRB-bundling, as presented herein. One or more aspects described for the network node 1202 may be performed by a component of a base station or a network entity, such as a CU, a DU, and/or an RU. Aspects of the network node 1202 may be implemented by the base station 102 of FIG. 1 and/or the base station 310 of FIG. 3. Aspects of the UE 1204 may be implemented by the UE 104 of FIG. 1 and/or the UE 350 of FIG. 3. Although not shown in the illustrated example of FIG. 12, in additional or alternative examples, the network node 1202 may be in communication with one or more other base stations or UEs, and/or the UE 1204 may be in communication with one or more other base stations or UEs.

In the illustrated example, the communication flow 1200 facilitates the UE 1204 performing PRB bundle-based PUCH transmissions, such as PUSCH and/or PUCCH. Aspects of the communication flow 1200 may be similar to the first retransmission procedure 1006 of FIG. 10 in which retransmissions are triggered based on a retransmission grant. Although the following description provides examples based on PUSCH transmissions, the concepts described may be applicable to the types of transmissions, such as PUCCH transmissions.

At 1206, the network node 1202 schedules the UE 1204 for a new PUSCH transmission. For example, the network node 1202 may transmit an uplink grant 1208 that is received by the UE 1204. Aspects of the uplink grant 1208 may be similar to the uplink grant 1010 of FIG. 10. The uplink grant 1208 may allocate resources 1230 for a new PUSCH transmission 1212. Aspects of the resources 1230 may be similar to the resources 1012 of FIG. 10. For example, the resources 1230 may allocate 30 PRBs to the UE 1204 to use for the new PUSCH transmission 1212.

At 1210, the UE 1204 generates the new PUSCH transmission 1212 including a payload 1232 (“Payload A”). Aspects of the payload 1232 may be similar to the transmission block 1102. In the example of FIG. 12, the payload 1232 of the new PUSCH transmission 1212 may be associated with an RV index 1234 of “rv.”

As shown in FIG. 12, the UE 1204 transmits the new PUSCH transmission 1212 that is received by the network node 1202. The UE 1204 may transmit the new PUSCH transmission 1212 based on the resources 1230 allocated for the payload 1232 based on the uplink grant 1208. For example, and referring to the example of FIG. 13, at 1300, a UE (e.g., the UE 1204 of FIG. 12) may transmit the new PUSCH transmission 1212 using an allocation of resources 1301 associated with the payload 1232. In the example of FIG. 13, the resources 1301 are associated with a slot N and each box of the resources 1301 may correspond to a PRB.

Referring again to the example of FIG. 12, at 1214, the network node 1202 determines whether decoding of the new PUSCH transmission 1212 is successful or unsuccessful. If, at 1214, the network node 1202 determines that decoding of the new PUSCH transmission 1212 is successful (e.g., the network node 1202 is able to decode the payload 1232 of the new PUSCH transmission 1212), then control may return to 1206 and the network node 1202 may schedule the UE 1204 for a new PUSCH transmission.

If, at 1214, the network node 1202 determines that decoding of the new PUSCH transmission 1212 is unsuccessful (e.g., the network node 1202 is unable to decode the payload 1232 of the new PUSCH transmission 1212), then the network node 1202 may schedule the UE 1204 to transmit a retransmission of at least a portion of the payload 1232 associated with a subset of resources corresponding to a lower quality channel. For example, at 1216, the network node 1202 may determine a PRB bundle granularity based on the received signal from the UE (e.g., the new PUSCH transmission 1212 from the UE 1204). The network node 1202 may determine the PRB granularity, sometimes referred to as a “sub-band allocation granularity” or a “PRB bundle size,” based on channel conditions. Aspects of determining channel conditions are described in connection with FIG. 9. The network node 1202 may use the channel conditions to determine which channels are good quality channels and which channels are lower quality channels. The network node 1202 may then determine the PRB bundle granularity, at 1216, by grouping consecutive PRBs with a same or similar channel conditions. As described above, the channels associated with the resources 1230 are flat fading channels and, thus, the PRB bundle size may include multiple PRB s.

Referring to the example of FIG. 13, at 1302, a network entity (e.g., the network node 1202 of FIG. 12) receives a first transmission (e.g., the new PUSCH transmission 1212 of FIG. 12). The network entity may receive the first transmission on the resources 1301 allocated to the transmission of the payload 1232. Based on channel conditions, the network entity may determine a PRB bundle granularity. For example, the network entity may determine that a first sub-band and a second sub-band are good quality channels and that the remaining sub-bands are lower quality channels. Based on the determination of good quality channels and lower quality channels, the network entity may group consecutive PRBs into PRB bundles. In the example of FIG. 13, the network entity groups the PRBs of the first sub-band as a first PRB bundle (“PRB Bundle #1”), groups the PRBs of the second sub-band as a second PRB bundle (“PRB Bundle #2”), groups the PRBs of the third sub-band as a third PRB bundle (“PRB Bundle #3”), groups the PRBs of the fourth sub-band as a fourth PRB bundle (“PRB Bundle #4”), and groups the PRBs of the fifth sub-band as a fifth PRB bundle (“PRB Bundle #5”). As shown in FIG. 13, each PRB bundle (e.g., at 1302) corresponds to six consecutive PRBs (e.g., at 1300).

It may be appreciated that in examples of a coverage UE that may be located at an edge of a coverage area, a UE may be allocated a small PRB allocation. In such examples, the bitmap size for the PRB bundling is also small.

Referring again to the example of FIG. 12, at 1218, the network node 1202 determines a bitmap to indicate the PRB bundles to be retransmitted and the PRB bundles to be skipped. The size of the bitmap may correspond to the quantity of PRB bundles. For example, and referring to the example of FIG. 13, at 1304, the network entity may generate a bitmap 1305. A bit value of “1” in the bitmap 1305 indicates that the corresponding PRB bundle is not to be retransmitted and a bit value of “0” indicates that the corresponding PRB bundle is to be transmitted. The order of bits in the bitmap 1305 is such that the PRB bundles are mapped in order from the smallest PRB bundle onwards starting from the most significant bit (MSB). For example, the MSB of the bitmap 1305 is indicated as bit 1305a and the bit value is “1.” In such an example, the bit value “1” of bit 1305a indicates that the PRBs associated with the first PRB bundle are not to be retransmitted.

Referring again to the example of FIG. 12, at 1220, the network node 1202 signals the PRB bundle granularity and the bitmap. For example, the network node 1202 may transmit DCI 1222 including the PRB bundle granularity and the bitmap (e.g., the bitmap 1305 of FIG. 13). The DCI 1222 may also request that the UE 1204 retransmit the payload 1232, as described in connection with the retransmission grant 1022 of FIG. 10.

The PRB bundle granularity may indicate the quantity of PRBs included in a PRB bundle. For example, the PRB bundle granularity may indicate that there are six PRBs in each PRB bundle. In some examples, the PRB bundle granularity may indicate the quantity of PRB bundles. For example, the PRB bundle granularity may indicate that there are five PRB bundles. In some examples, the PRB bundle granularity may indicate a quantity of PRBs associated with each PRB bundle. For example, the network node 1202 may determine to group different quantities of PRBs into different PRB bundles. In such example, the PRB bundle granularity may indicate the quantity of PRBs included in each of the respective PRB bundles.

At 1224, the UE 1204 retransmits the PUSCH with the same RV index “rv” by discarding or puncturing the PRB bundles associated with the “1” indication in the bitmap. For example, the UE 1204 may transmit a PUSCH 1226 corresponding to a retransmission of the payload 1232 with the same RV index as the payload 1232. The PUSCH 1226 may include the portions of the payload 1232 corresponding to the PRB bundles indicated as lower quality channels.

For example, and referring to the example of FIG. 13, at 1306, the UE may transmit a UE transmission corresponding to the PUSCH 1226 of FIG. 12. The UE transmission of FIG. 13 includes the PRBs associated with the third PRB bundle, the fourth PRB bundle, and the fifth PRB bundle. That is, the UE transmission, at 1306, includes the portions of the payload 1232 associated with the PRBs of the third PRB bundle, the fourth PRB bundle and the fifth PRB bundle. As shown in FIG. 13, the UE may transmit the UE transmission at a subsequent slot (e.g., at a slot N+K).

In one example, the UE may transmit the UE transmission with the subset of PRB bundles based on puncturing the PRB bundles associated with good quality channels after a mapping stage, as described in connection with 1160 of FIG. 11. For example, the UE may generate a retransmission of the payload 1232 and perform a same rate matching as the rate matching applied to the payload 1232 of the new PUSCH transmission 1212. In the example of FIG. 13, the UE may perform modulation 1308 (“QAM”) and map the payload (e.g., at mapping 1310) to a set of PRBs. At 1312, the UE may puncture the PRBs based on the bitmap 1305. For example, the UE may puncture the PRBs that are associated with the first PRB bundle and the second PRB bundle based on the “1” indication in the MSB (e.g., the bit 1305a) and the next MSB of the bitmap 1305. Thus, the UE transmission, at 1306, includes the PRBs associated with the third PRB bundle, the fourth PRB bundle, and the fifth PRB bundle. In the example of FIG. 13, the UE transmission at 1306 includes fewer PRBs than the first transmission at 1302. In such examples, the power density associated with the UE transmission at 1306 may be greater than the power density associated with the first transmission at 1302.

In the example of FIG. 13, the UE may puncture the PRBs associated with the one or more PRB bundles before performing an IFFT, at 1314, to produce a physical channel carrying a time domain OFDM symbol stream associated with the payload.

As shown in FIG. 13, the PRBs of the PRB bundles at 1302 and the PRBs of the PRB bundles at 1306 are each associated with a starting PRB (e.g., “Start PRB”). In some examples, the staring PRBs may be the same PRB. In other examples, the starting PRBs may be different PRBs. Thus, the network node may allocate different frequency resources for the retransmission (e.g., the starting PRB of the UE transmission at 1306 may be different than the starting PRB of the first transmission at 1302).

Although the examples of FIG. 12 and FIG. 13 describe retransmission of the payload over a single slot, in other examples, the retransmission of the payload may be applied over multiple slots. For example, if a transport block is split over multiple slots, which may be indicated by a “TBoMS” parameter or by another name, the PRB bundle granularity and the bitmap may apply for the multiple slots. For example, with a flat fading channel, the channel conditions over time may be similar and, thus, the PRB bundle granularity and the bitmap may be applicable across the multiple slots.

Although the examples of FIG. 12 and FIG. 13 describe a sub-allocation in the frequency domain (e.g., the PRB bundles are based on grouping PRBs in the same sub-band), in other examples, the sub-allocation may additionally or alternatively be applied in the time domain. For example, a PRB may include 12 symbols, which may be indicated by a “numOfPuschSymbols” parameter or by another name, and a “time bundle” may indicate a sub-allocation of four OFDM symbols. Thus, the PRB may be grouped into three time bundles of four OFDM symbols each.

In the examples of FIG. 12 and FIG. 13, the retransmission is a DCI-based retransmission in which the network node transmits DCI requesting that the UE retransmit the payload. In other examples, the retransmission may be based on a repetition factor.

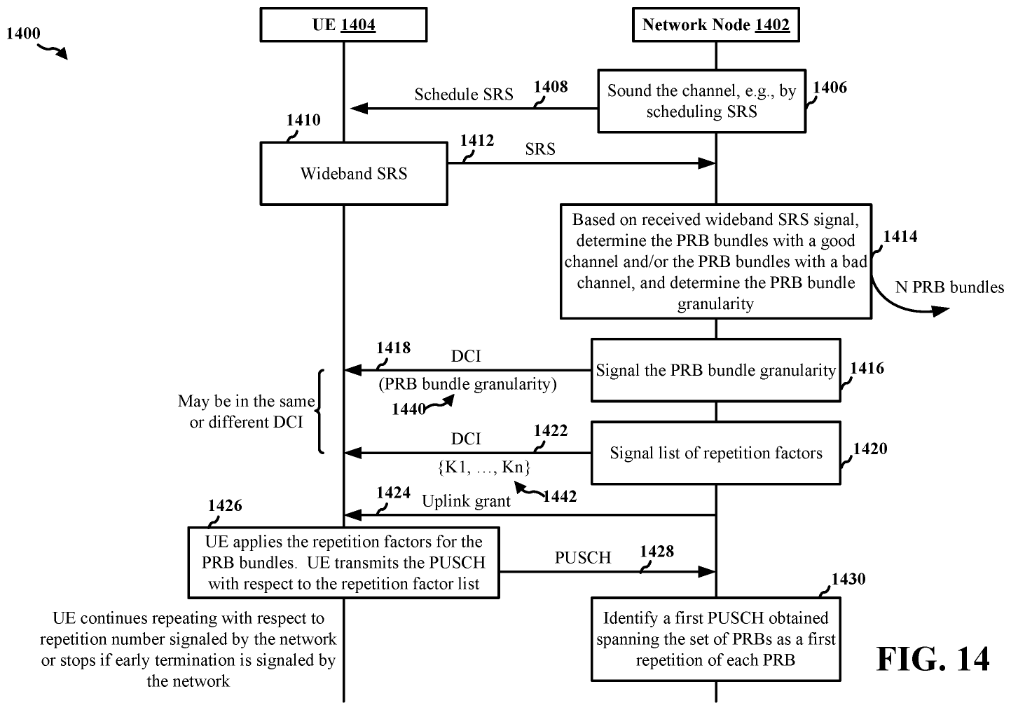

FIG. 14 illustrates an example communication flow 1400 between a network node 1402 and a UE 1404, as presented herein. One or more aspects described for the network node 1402 may be performed by a component of a base station or a network entity, such as a CU, a DU, and/or an RU. Aspects of the network node 1402 may be implemented by the base station 102 of FIG. 1 and/or the base station 310 of FIG. 3. Aspects of the UE 1404 may be implemented by the UE 104 of FIG. 1 and/or the UE 350 of FIG. 3. Although not shown in the illustrated example of FIG. 14, in additional or alternative examples, the network node 1402 may be in communication with one or more other base stations or UEs, and/or the UE 1404 may be in communication with one or more other base stations or UEs.

In the illustrated example, the communication flow 1400 facilitates the UE 1404 performing PRB bundle-based PUCH transmissions, such as PUSCH and/or PUCCH. Aspects of the communication flow 1400 may be similar to the second retransmission procedure 1050 of FIG. 10 in which retransmissions are based on a repetition factor. Although the following description provides examples based on PUSCH transmissions, the concepts described may be applicable to the types of transmissions, such as PUCCH transmissions.

At 1406, the network node 1402 sounds the channels. The network node 1402 may sound the channel to determine the characteristics of the channel. For example, sounding the channel may allow the base station 102 to determine where there is flat fading on a channel, how much is the flat fading, etc. The network node 1402 may transmit scheduling information 1408 associated with sounding the channel that is received by the UE 1404. For example, the scheduling information 1408 may schedule the UE 1404 to transmit an uplink reference signal that may be used by the network node 1402 to perform sounding. In the illustrated example of FIG. 14, the network node 1402 schedules the UE 1404 to transmit an SRS. At 1410, the UE generates a wideband SRS, for example, based on the scheduling information 1408. As shown in FIG. 14, the UE 1404 transmits an SRS 1412 that is received by the network node 1402.

At 1414, the network node 1402 determines PRB bundles associated with good channels (e.g., good quality channels) and bad channels (e.g., lower quality channels). Aspects of determining the PRB bundles associated with the good channels and the bad channels are described in connection with the example of FIG. 9. The network node 1402 may also determine the PRB bundle granularity based on the PRB bundles. Similar to the example of the first transmission at 1302 of FIG. 13, the network node 1402 may determine which channels are good quality channels and lower quality channels and group the PRBs based on the channel conditions. As shown in FIG. 14, the network node 1402 may determine to group the PRBs into N PRB bundles.

At 1416, the network node 1402 may signal the PRB bundle granularity. For example, the network node 1402 may transmit DCI 1418 that is received by the UE 1404. The DCI 1418 may include a PRB bundle granularity 1440. The PRB bundle granularity 1440 may indicate the quantity of PRB bundles (e.g., N PRB bundles). In other examples, the PRB bundle granularity 1440 may indicate a quantity of PRBs included in a PRB bundle, and/or may indicate a quantity of PRBs included in respective PRB bundles.

At 1420, the network node 1402 may signal a list of repetition factors. For example, the network node 1402 may transmit DCI 1422 that is received by the UE 1404. The DCI 1422 may include information 1442 indicating a set of repetition factors. Each repetition factor of the set of repetition factors may correspond to a respective PRB bundle. For example, based on the N PRB bundles (e.g. indicated by the PRB bundle granularity 1440), the information 1442 may include a set of repetition factors {K1, . . . , Kn} in which a first repetition “K1” corresponds to a quantity of repetitions of the first PRB bundle, . . . , and the nth repetition factor “Kn” corresponds to a quantity of repetitions of the Nth PRB bundle.

Although FIG. 14 includes an example in which the information 1442 includes a set (or a list) of repetition factors, in other examples, the information 1442 may point to a row index of a time domain resource assignment (TDRA) table. The UE 1404 may receive signaling associated with the TDRA table via an RRC configuration procedure and/or an RRC reconfiguration procedure with the network node 1402.

As shown in FIG. 14, the network node 1402 also transmits an uplink grant 1424 that is received by the UE 1404. Aspects of the uplink grant 1424 may be similar to the uplink grant 1052 of FIG. 10 scheduling the UE 1404 to transmit a payload. The uplink grant 1424 may allocate resources that include channels sounded by the SRS 1412. That is, the resources allocated by the uplink grant 1424 may include a subset of sub-bands of the wideband SRS.

Although shown as separate transmissions in the example of FIG. 14, it may be appreciated that the DCI 1418, the DCI 1422, and/or the uplink grant 1424 may correspond to a same DCI or to different DCIs.

At 1426, the UE 1404 applies the repetition factors for the respective PRB bundles. For example, the UE 1404 may transmit PUSCH 1428 with respect to the repetition factor list (e.g., the information 1442). For example, for the first repetition of the PUSCH 1428 (e.g., an initial transmission of the corresponding payload), the UE 1404 may transmit all PRB bundles {Bundle-1, . . . , Bundle-N}. Subsequent repetitions of the PUSCH 1428 may include fewer PRB bundles. The repetition factor applied for a Bundle-j is K-j.

At 1430, the network node 1402 may identify a first PUSCH obtained spanning the set of PRBs as a first repetition of each PRB. For example, the network node 1402 may identify the first repetition of the PUSCH 1428 including all PRB bundles {Bundle-1, . . . , Bundle-N} as the first repetition of each respective PRB.

The UE 1404 may continue transmitting repetitions of PRB bundles based on the repetition factor associated with the respective PRB bundle until a termination event occurs, such as the quantity of repetition factors associated with a PRB bundle is reached, a repetition timer expires, or early termination is signaled by the network (e.g., such as the terminate message 1080 of FIG. 10).

In the example of FIG. 14, each PRB bundle has a same RV index, as described in connection with the example of Chase combining HARQ and the examples of FIG. 12 and FIG. 13. Each PRB bundle is also associated with a repetition factor. The value of the repetition factors may be indicated by a “repK-r17” parameter of a “ConfiguredGrantConfig” information element. The value range of repetition factors may include {1, 2, 4, 8, 12, 16, 24, 32}. Thus, each PRB bundle is associated with a repetition factor of at least one. In this manner, each PRB bundle is transmitted at least once. That is, in contrast to the example of FIG. 12, the UE 1404 of FIG. 14 does not perform discarding or puncturing of any of the PRB bundles. However, certain PRB bundles may be associated with greater repetition factors that other PRB bundles.

For example, PRB bundles associated with good quality channels may have a repetition factor of 1, while PRB bundles associated with lower quality channels may have a repetition factor greater than 1. In some examples, the PRB bundles may be characterized in tiers, as described in connection with the example of FIG. 8D. For example, PRB bundles associated with good quality channels may have a repetition factor of 1, PRB bundles associated with medium quality channels may have a repetition factor of 4, and PRB bundles associated with lower quality channels may have a repetition factor of 12.

In the example of FIG. 14, the network node 1402 sounds the channel based on the SRS 1412. In other examples, the network node 1402 may sound the channel based on another transmission received by the network node 1402. For example, the network node 1402 may receive a first transmission and sound the channel based on the first transmission. The network node 1402 may then determine the PRB bundle granularity, the list of repetition factors, and the resources indicated by the uplink grant 1424 based on the first transmission. The PRB bundle granularity, the list of repetition factors, and the resources indicated by the uplink grant 1424 may be associated with a second transmission that occurs after the first transmission is received.

Similar to the example of FIG. 12, the repetition factors may be applied over multiple slots. Additionally, the sub-allocation of resources may be in the frequency domain (e.g., based on channels) and/or in the time domain (e.g., based on a quantity of OFDM symbols).

In the illustrated example of FIG. 14, the network node 1402 indicates a repetition factor for each PRB bundle before receiving an initial transmission of the payload. Since the UE 1404 needs to transmit each PRB bundle at least once, the example of FIG. 14 does not include a bitmap. However, in other examples, the network node may provide a list of repetition factors after receiving an initial transmission of payload.

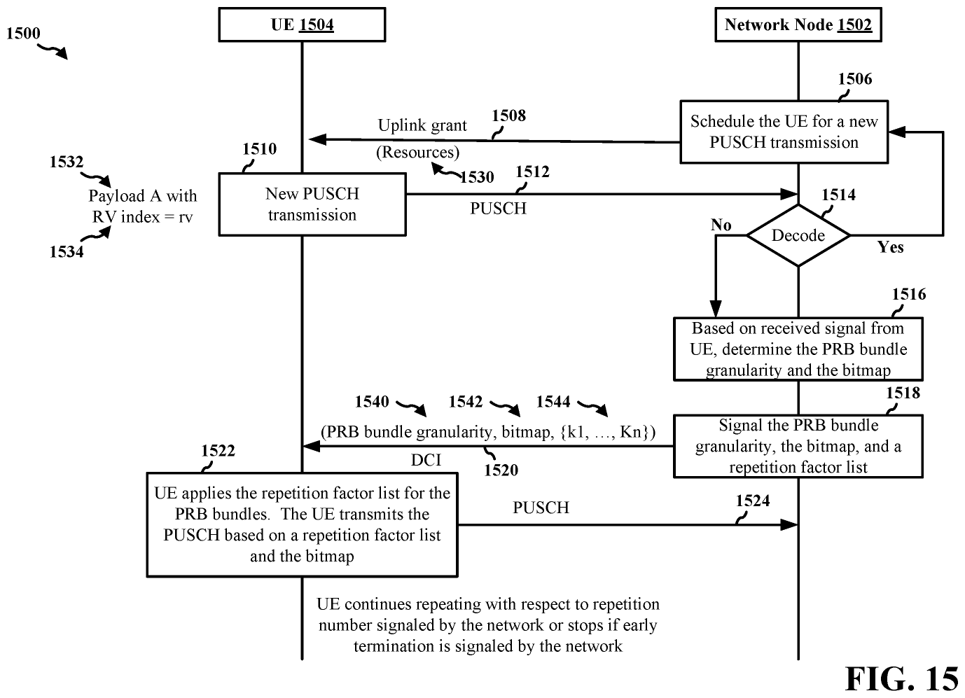

FIG. 15 illustrates an example communication flow 1500 between a network node 1502 and a UE 1504, as presented herein. One or more aspects described for the network node 1502 may be performed by a component of a base station or a network entity, such as a CU, a DU, and/or an RU. Aspects of the network node 1502 may be implemented by the base station 102 of FIG. 1 and/or the base station 310 of FIG. 3. Aspects of the UE 1504 may be implemented by the UE 104 of FIG. 1 and/or the UE 350 of FIG. 3. Although not shown in the illustrated example of FIG. 15, in additional or alternative examples, the network node 1502 may be in communication with one or more other base stations or UEs, and/or the UE 1504 may be in communication with one or more other base stations or UEs.

In the illustrated example, the communication flow 1500 facilitates the UE 1504 performing PRB bundle-based PUCH transmissions, such as PUSCH and/or PUCCH. Aspects of the communication flow 1500 may be similar to the first retransmission procedure 1006 of FIG. 10 and the second retransmission procedure 1050 in which the UE 1504 receives a retransmission grant to transmit a retransmission of a PUCH transmission, but the retransmission grant may include information related to repetition factors (e.g., a list of repetition factors) indicating a quantity of repetitions associated with respective PRB bundles. Although the following description provides examples based on PUSCH transmissions, the concepts described may be applicable to the types of transmissions, such as PUCCH transmissions.

At 1506, the network node 1502 schedules the UE 1504 for a new PUSCH transmission. For example, the network node 1502 may transmit an uplink grant 1508 that is received by the UE 1504. Aspects of the uplink grant 1508 may be similar to the uplink grant 1010 of FIG. 10. The uplink grant 1508 may allocate resources 1530 for a new PUSCH transmission 1512. Aspects of the resources 1530 may be similar to the resources 1012 of FIG. 10. For example, the resources 1530 may allocate 30 PRBs to the UE 1504 to use for the new PUSCH transmission 1512.

At 1510, the UE 1504 generates the new PUSCH transmission 1512 including a payload 1532 (“Payload A”). Aspects of the payload 1532 may be similar to the transmission block 1102. In the example of FIG. 15, the payload 1532 of the new PUSCH transmission 1512 may be associated with an RV index 1534 of “rv.”

As shown in FIG. 15, the UE 1504 transmits the new PUSCH transmission 1512 that is received by the network node 1502. The UE 1504 may transmit the new PUSCH transmission 1512 based on the resources 1530 allocated for the payload 1532 based on the uplink grant 1508, as described in connection with the resources 1301 of FIG. 13.

At 1514, the network node 1502 determines whether decoding of the new PUSCH transmission 1512 is successful or unsuccessful. If, at 1514, the network node 1502 determines that decoding of the new PUSCH transmission 1512 is successful (e.g., the network node 1502 is able to decode the payload 1532 of the new PUSCH transmission 1512), then control may return to 1506 and the network node 1502 may schedule the UE 1504 for a new PUSCH transmission.

If, at 1514, the network node 1502 determines that decoding of the new PUSCH transmission 1512 is unsuccessful (e.g., the network node 1502 is unable to decode the payload 1532 of the new PUSCH transmission 1512), then the network node 1502 may schedule the UE 1504 to transmit a retransmission of at least a portion of the payload 1532 associated with a subset of resources corresponding to a lower quality channel. For example, at 1516, the network node 1502 may determine a PRB bundle granularity based on the received signal from the UE (e.g., the new PUSCH transmission 1512 from the UE 1504). The network node 1502 may determine the PRB granularity based on channel conditions. Aspects of determining channel conditions are described in connection with FIG. 9. The network node 1502 may use the channel conditions to determine which channels are good quality channels and which channels are lower quality channels. The network node 1502 may then determine the PRB bundle granularity, at 1516, by grouping consecutive PRBs with a same or similar channel conditions. As described above, the channels associated with the resources 1530 are flat fading channels and, thus, the PRB bundle size may include multiple PRBs. Aspects of determining the PRB bundle granularity are described in connection with 1216 of FIG. 12. The network node 1502 may also determine, at 1516, a bitmap to indicate the PRB bundles to be retransmitted and the PRB bundles to be skipped. Aspects of determining the bitmap are described in connection with 1218 of FIG. 12.

At 1518, the network node 1502 signals the PRB bundle granularity, the bitmap, and information regarding repetition factors (e.g., a list of repetition factors). For example, the network node 1502 may transmit DCI 1520 that is received by the UE 1504. In the example of FIG. 15, the DCI 1520 includes a PRB bundle granularity 1540, a bitmap 1542, and information 1544. Aspects of the PRB bundle granularity 1540 may be similar to the PRB bundle granularity at 1216 of FIG. 12 and/or the PRB bundle granularity 1440 of FIG. 14. Aspects of the bitmap 1542 may be similar to the bitmap 1305 of FIG. 13. Aspects of the information 1544 may be similar to the information 1442 of FIG. 14.

Although FIG. 15 includes an example in which the information 1544 includes a set (or a list) of repetition factors, in other examples, the information 1544 may point to a row index of a TDRA table. The UE 1504 may receive signaling associated with the TDRA table via an RRC configuration procedure and/or an RRC reconfiguration procedure with the network node 1502.

At 1522, the UE 1504 applies the repetition factors for the respective PRB bundles. For example, the UE 1504 may transmit PUSCH 1524 based on PRB bundle granularity 1540, the bitmap 1542, and the information 1544. For example, the UE 1504 may use the PRB bundle granularity 1540 to determine how many PRBs are included in each PRB bundle and the quantity of PRB bundles. For example, if the UE 1504 is allocated 30 PRBs in the resources 1530 of the uplink grant 1508 and the PRB bundle granularity 1540 indicates that there are six PRBs in each PRB bundle, then the UE 1504 may determine that there are five PRB bundles. The UE 1504 may use the bitmap 1542 to determine which PRB bundles to retransmit and which PRB bundles to discard or puncture. The UE 1504 may use the information 1544 to determine how many repetitions to transmit of each PRB bundle indicated to be retransmit, for example, by the bitmap 1542. In an example in which the PRB bundles include {Bundle-1, . . . , Bundle-N} and the information 1544 includes a list of repetition factors {K1, . . . , Kn}, the repetition applied for a Bundle-j is K-j.

Similar to the examples of FIG. 12 and FIG. 14, each PRB bundle of a repetition has a same RV index as the initial transmission, as described in connection with the example of Chase combining HARQ and the examples of FIG. 12 and FIG. 13.

Similar to the example of FIG. 14, the UE 1504 may continue transmitting repetitions of PRB bundles based on the repetition factor associated with the respective PRB bundle until a termination event occurs, such as the quantity of repetition factors associated with a PRB bundle is reached, a repetition timer expires, or early termination is signaled by the network (e.g., such as the terminate message 1080 of FIG. 10).

Similar to the examples of FIG. 12 and FIG. 14, the repetition factors may be applied over multiple slots. Additionally, the sub-allocation of resources may be in the frequency domain (e.g., based on channels) and/or in the time domain (e.g., based on a quantity of OFDM symbols).

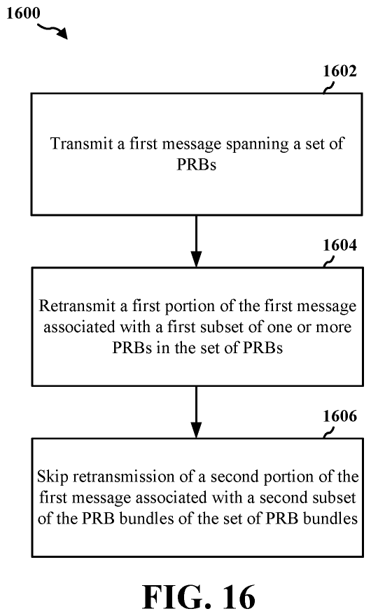

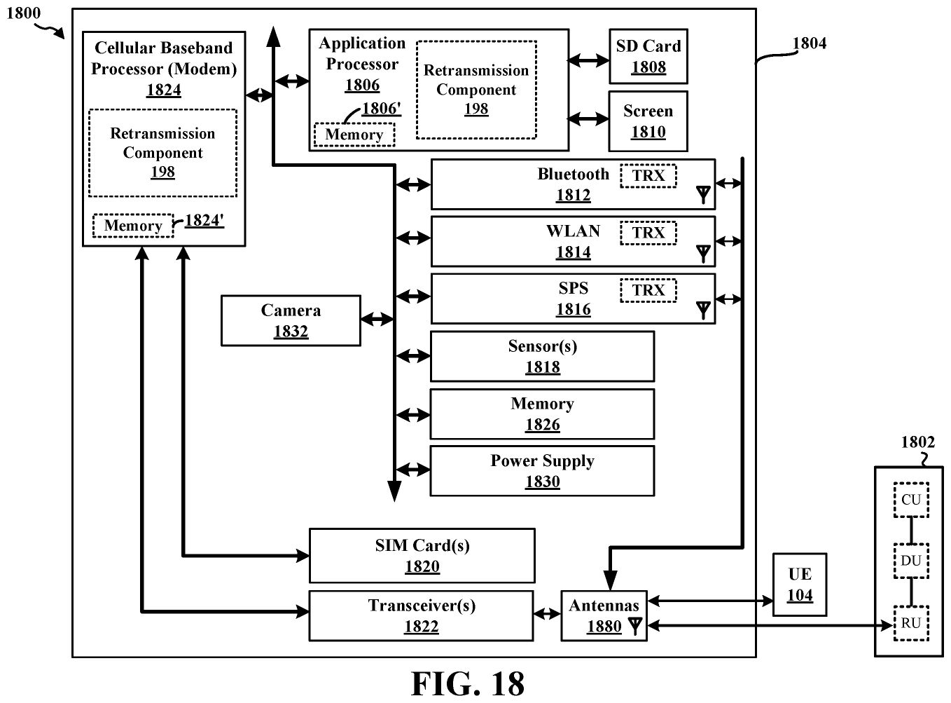

FIG. 16 is a flowchart 1600 of a method of wireless communication. The method may be performed by a wireless device such as a UE (e.g., the UE 104, 350, and/or an apparatus 1804 of FIG. 18). The method may facilitate improving cell coverage by enabling a UE to transmit retransmission of an uplink message using a lower PRB allocation and, thus, a higher PRB power density.

At 1602, the wireless device transmits a first message spanning a set of PRBs. The transmission may be performed, e.g., by one or more of the retransmission component 198, cellular baseband processor 1824, transceiver 1822, and/or antennas 1880 of the apparatus 1804 in FIG. 18.

At 1604, the wireless device retransmits a first portion of the first message associated with a first subset of one or more PRBs in the set of PRBs, the set of PRBs grouped into a set of PRB bundles including a first subset of PRB bundles corresponding to the first subset of the one or more PRBs. The retransmission may be performed, e.g., by one or more of the retransmission component 198, cellular baseband processor 1824, transceiver 1822, and/or antennas 1880 of the apparatus 1804 in FIG. 18.

At 1606, the wireless device skips retransmission of a second portion of the first message associated with a second subset of the PRB bundles of the set of PRB bundles, the second subset of the PRB bundles corresponding to at least a portion of remaining PRBs in the set of PRBs. The skipping may be performed, e.g., by the retransmission component 198 of the apparatus 1804 in FIG. 18.

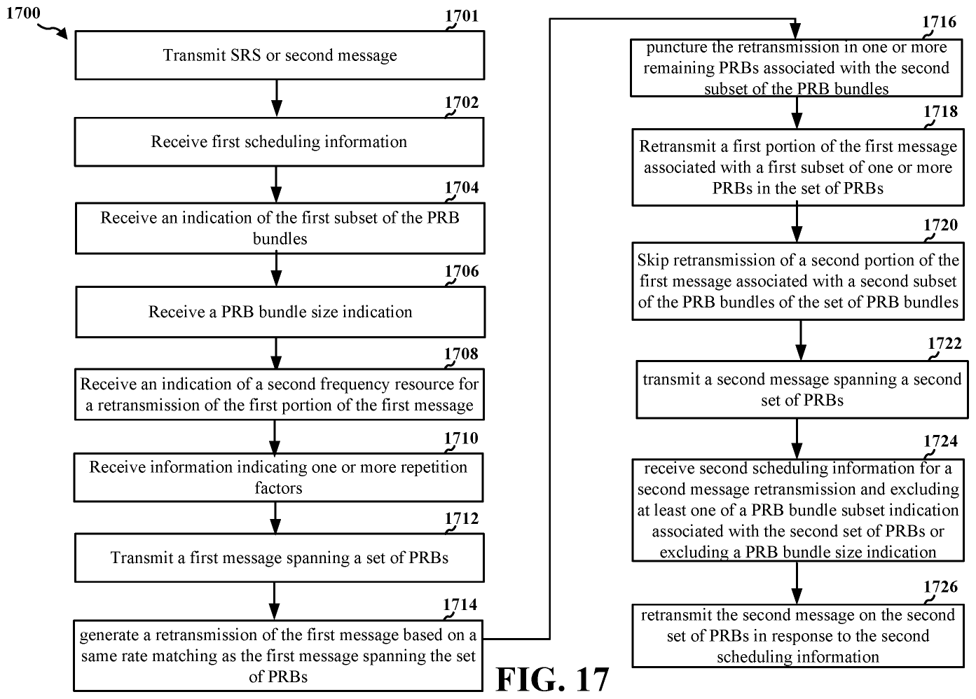

FIG. 17 is a flowchart 1700 of a method of wireless communication. The method may be performed by a wireless device such as a UE (e.g., the UE 104, 350, and/or an apparatus 1804 of FIG. 18). The method may facilitate improving cell coverage by enabling a UE to transmit retransmission of an uplink message using a lower PRB allocation and, thus, a higher PRB power density.

At 1712, the wireless device transmits a first message spanning a set of PRBs. The transmission may be performed, e.g., by one or more of the retransmission component 198, cellular baseband processor 1824, transceiver 1822, and/or antennas 1880 of the apparatus 1804 in FIG. 18. In some aspects, the first message over the set of PRBs may span a first duration and retransmission of the first portion of the first message over the first subset of the PRB bundles spans a second duration that is shorter than the first duration. In some aspects, the first message may comprise a PUSCH message or a PUCCH message.

At 1718, the wireless device retransmits a first portion of the first message associated with a first subset of one or more PRBs in the set of PRBs, the set of PRBs grouped into a set of PRB bundles including a first subset of PRB bundles corresponding to the first subset of the one or more PRBs. The retransmission may be performed, e.g., by one or more of the retransmission component 198, cellular baseband processor 1824, transceiver 1822, and/or antennas 1880 of the apparatus 1804 in FIG. 18. In some aspects, a retransmission of the first portion of the first message associated with the first subset of the PRB bundles, at 1718, may span multiple slots.

At 1720, the wireless device skips retransmission of a second portion of the first message associated with a second subset of the PRB bundles of the set of PRB bundles, the second subset of the PRB bundles corresponding to at least a portion of remaining PRBs in the set of PRBs. The skipping may be performed, e.g., by the retransmission component 198 of the apparatus 1804 in FIG. 18.

In some aspects, as illustrated at 1702, the wireless device may further receive first scheduling information for retransmission of the first message, and at 1704 may receive an indication of the first subset of the PRB bundles. The reception may be performed, e.g., by the retransmission component 198 of the apparatus 1804 in FIG. 18. In some aspects, the indication may include a bitmap indicating to retransmit or to skip the retransmission of a respective portion of the first message associated with each PRB bundle in the set of PRB bundles.

As illustrated at 1706, the wireless device may receive a PRB bundle size indication that indicates a quantity of PRBs included in each PRB bundle of the set of PRB bundles.

As illustrated at 1722, the wireless device may transmit a second message spanning a second set of PRBs, and may receive second scheduling information for a second message retransmission, the second scheduling information excluding at least one of a PRB bundle subset indication associated with the second set of PRBs or excluding a PRB bundle size indication, at 1724. The transmission and the reception may be performed, e.g., by the retransmission component 198 of the apparatus 1804 in FIG. 18. Then, at 1726, the wireless device may retransmit the second message on the second set of PRBs in response to the second scheduling information. The retransmission may be performed, e.g., by the retransmission component 198. In some aspects, the first scheduling information and the indication of the first subset of the PRB bundles may be received, at 1702 and 1704, after transmission of the first message, e.g., rather than prior to the first message, at 1712.

In some aspects, the first message on the set of PRBs, at 1712, and a retransmission, at 1718, of the first portion associated with the first subset of the one or more PRBs have a same redundancy version (RV).

As illustrated at 1714, the wireless device may generate a retransmission of the first message based on a same rate matching as the first message spanning the set of PRBs, and, at 1716, the wireless device may puncture the retransmission in one or more remaining PRBs associated with the second subset of the PRB bundles. The generation and/or the puncturing may be performed, e.g., by the retransmission component 198 of the apparatus 1804 in FIG. 18.

In some aspects, as illustrated at 1701, the wireless device may transmit, prior to transmission of the first message, a SRS or a second message on the set of PRBs. The SRS may be transmitted by a component of the cellular baseband processor 1824, transceiver 1822, and/or antennas 1880. Then, at 1702, the wireless device may receive scheduling information for the transmission of the first message spanning the set of PRBs. The reception may be performed, e.g., by the retransmission component 198 of the apparatus 1804 in FIG. 18. The scheduling information may include a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one, and wherein the transmission of the first message spanning the set of PRBs corresponds to a first repetition of each PRB bundle of the set of PRB bundles.

As illustrated at 1710, the wireless device may receive scheduling information for the first message, the scheduling information indicating a respective repetition factor for each PRB bundle of the first subset of the PRB bundles. The reception may be performed, e.g., by the retransmission component 198 of the apparatus 1804 in FIG. 18.

As illustrated at 1706, the wireless device may receive a PRB bundle size indication that indicates a quantity of PRBs included in each PRB bundle of the set of PRB bundles, and at 1710, the wireless device may receive information indicating one or more repetition factors, wherein each repetition factor of the one or more repetition factors is associated with a corresponding PRB bundle in the set of PRB bundles based on the PRB bundle size indication. The reception may be performed, e.g., by the retransmission component 198 of the apparatus 1804 in FIG. 18.

As illustrated at 1708, the wireless device may receive an indication of a second frequency resource for a retransmission of the first portion of the first message that is different than a first frequency resource for the first message. The reception may be performed, e.g., by the retransmission component 198 of the apparatus 1804 in FIG. 18.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers (e.g., the cellular RF transceiver 1822). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize one or more antennas 1880 for communication. The cellular baseband processor 1824 communicates through transceiver(s) (e.g., the cellular RF transceiver 1822) via one or more antennas 1880 with the UE 104 and/or with an RU associated with a network entity 1802. The cellular baseband processor 1824 and the application processor 1806 may each include a computer-readable medium/memory, such as the on-chip memory 1824′, and the on-chip memory 1806′, respectively. The additional memory modules 1826 may also be considered a computer-readable medium/memory. Each computer-readable medium/memory (e.g., the on-chip memory 1824′, the on-chip memory 1806′, and/or the additional memory modules 1826) may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see the UE 350 of FIG. 3) and include the additional modules of the apparatus 1804.

As discussed supra, the retransmission component 198 is configured to transmit a first message spanning a set of PRBs, retransmit a first portion of the first message associated with a first subset of one or more PRBs in the set of PRBs, the set of PRBs grouped into a set of PRB bundles including a first subset of PRB bundles corresponding to the first subset of the one or more PRBs, and skip retransmission of a second portion of the first message associated with a second subset of the PRB bundles of the set of PRB bundles, the second subset of the PRB bundles corresponding to at least a portion of remaining PRBs in the set of PRBs. The retransmission component 198 and/or another component of the cellular baseband processor 1824, the application processor 1806, or both, may be configured to further perform any of the aspects described in connection with FIG. 16, FIG. 17, and/or any of the aspects performed by the UE in any of 1, FIG. 3, FIG. 4, FIG. 12, FIG. 14, or FIG. 15. The retransmission component 198 may be within the cellular baseband processor 1824, the application processor 1806, or both the cellular baseband processor 1824 and the application processor 1806. The retransmission component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1804 may include a variety of components configured for various functions. For example, the retransmission component 198 may further include one or more hardware components that perform each of the blocks of the algorithm in the flowcharts of FIG. 16 and/or FIG. 17.

In one configuration, the apparatus 1804, and in particular the cellular baseband processor 1824 and/or the application processor 1806, includes means for transmitting a first message spanning a set of PRBs, means for retransmitting a first portion of the first message associated with a first subset of one or more PRBs in the set of PRBs, the set of PRBs grouped into a set of PRB bundles including a first subset of PRB bundles corresponding to the first subset of the one or more PRBs, and means for skipping retransmission of a second portion of the first message associated with a second subset of the PRB bundles of the set of PRB bundles, the second subset of the PRB bundles corresponding to at least a portion of remaining PRBs in the set of PRBs. The apparatus may further include means for receiving first scheduling information for retransmission of the first message. The apparatus may further include means for receiving an indication of the first subset of the PRB bundles. The apparatus may further include means for receiving a PRB bundle size indication that indicates a quantity of PRBs included in each PRB bundle of the set of PRB bundles. The apparatus may further include means for transmitting a second message spanning a second set of PRBs. The apparatus may further include means for receiving second scheduling information for a second message retransmission, the second scheduling information excluding at least one of a PRB bundle subset indication associated with the second set of PRBs or excluding a PRB bundle size indication; and means for retransmitting the second message on the second set of PRBs in response to the second scheduling information. The apparatus may further include means for generating a retransmission of the first message based on a same rate matching as the first message spanning the set of PRB s; and means for puncturing the retransmission in one or more remaining PRBs associated with the second subset of the PRB bundles. The apparatus may further include means for transmitting, prior to transmission of the first message, a SRS or a second message on the set of PRBs, and means for receiving scheduling information for the transmission of the first message spanning the set of PRBs, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one, and wherein the transmission of the first message spanning the set of PRBs corresponds to a first repetition of each PRB bundle of the set of PRB bundles. The apparatus may further include means for receiving scheduling information for the first message, the scheduling information indicating a respective repetition factor for each PRB bundle of the first subset of the PRB bundles. The apparatus may further include means for receiving a PRB bundle size indication that indicates a quantity of PRBs included in each PRB bundle of the set of PRB bundles; and means for receiving information indicating one or more repetition factors, wherein each repetition factor of the one or more repetition factors is associated with a corresponding PRB bundle in the set of PRB bundles based on the PRB bundle size indication. The apparatus may further include means for receiving an indication of a second frequency resource for a retransmission of the first portion of the first message that is different than a first frequency resource for the first message. In one configuration, the apparatus 1804, and in particular the cellular baseband processor 1824 and/or the application processor 1806, includes means for performing any of the aspects of the methods of FIG. 16 and/or FIG. 17. The means may be the retransmission component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

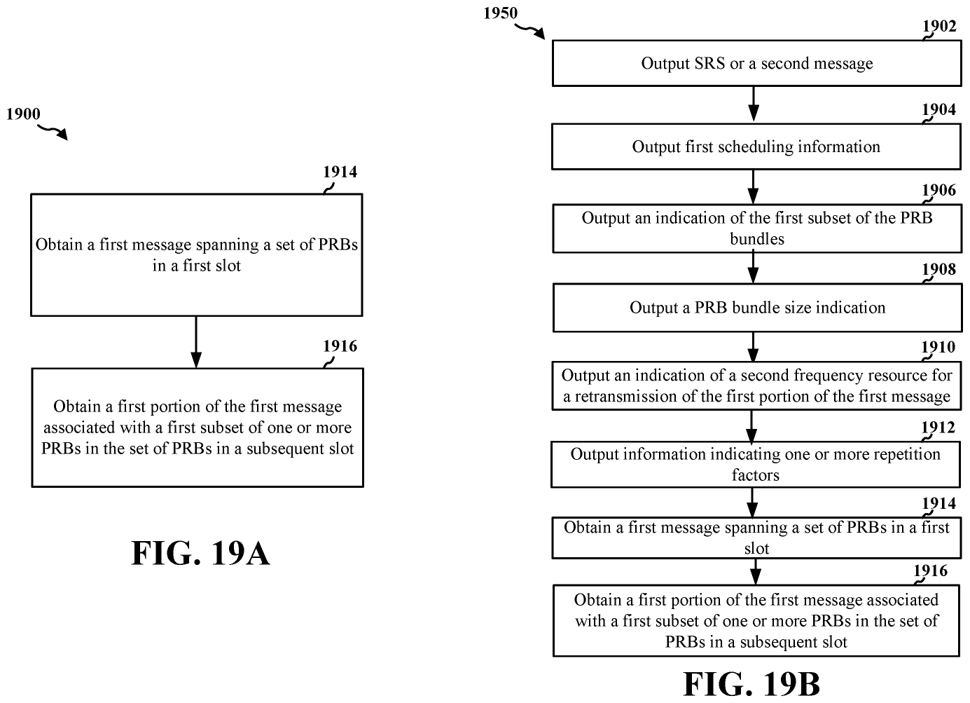

FIG. 19A is a flowchart 1900 of a method of wireless communication. The method may be performed by a network entity, which may include an aggregated base station and/or one or more components of a disaggregated base station such as a CU, DU, or RU (e.g., the base station 102, 310, and/or a network entity 1802 of FIG. 18). The method may facilitate improving cell coverage by enabling a UE to transmit retransmission of an uplink message using a lower PRB allocation and, thus, a higher PRB power density.

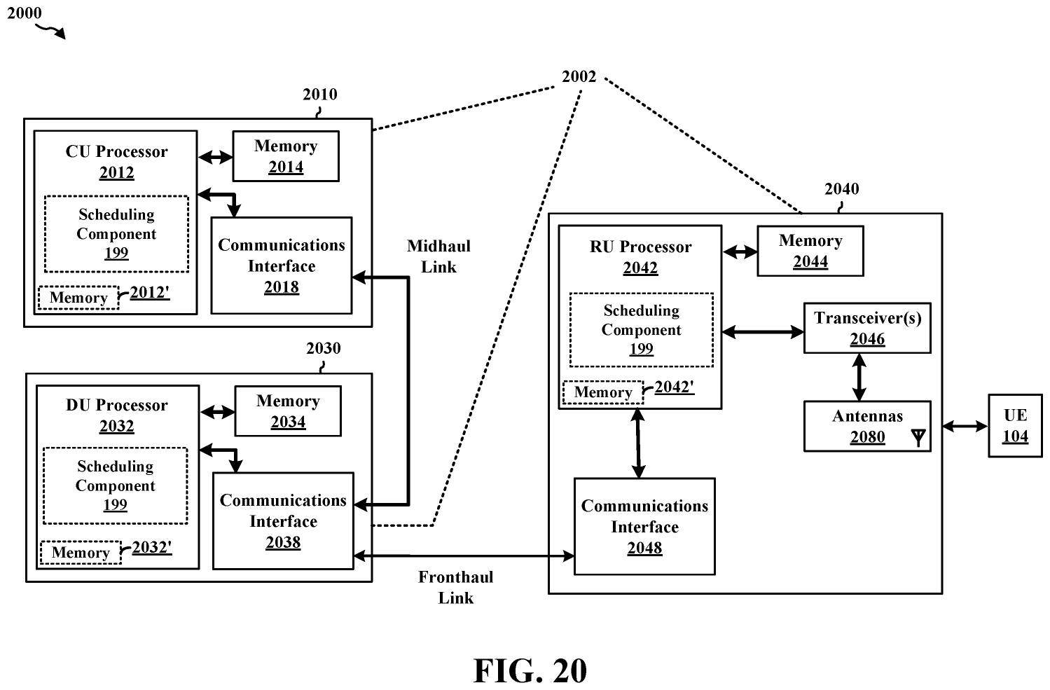

At 1914, the network entity obtains a first message spanning a set of PRBs in a first slot. As an example, the network entity may receive the first message spanning the set of PRBs. The obtaining may be performed by the scheduling component 199 of the network entity 2002 of FIG. 20.

At 1916, the network entity obtains a first portion of the first message associated with a subset of one or more PRBs in the set of PRBs in a subsequent slot, the set of PRBs grouped into a set of PRB bundles including a first subset of PRB bundles corresponding to the subset of the one or more PRBs. The obtaining may be performed by the scheduling component 199 of the network entity 2002 of FIG. 20. In some aspects, the first message on the set of PRBs, at 1914, and the first portion of the first message on the subset of the one or more PRBs, at 1916 may have a same RV.

FIG. 19B is a flowchart 1950 of a method of wireless communication. The method may be performed by a network entity, which may include an aggregated base station and/or one or more components of a disaggregated base station such as a CU, DU, or RU (e.g., the base station 102, 310, and/or a network entity 1802 of FIG. 18). The method may facilitate improving cell coverage by enabling a UE to transmit retransmission of an uplink message using a lower PRB allocation and, thus, a higher PRB power density.

At 1914, the network entity obtains a first message spanning a set of PRBs in a first slot. As an example, the network entity may receive the first message spanning the set of PRBs. The obtaining may be performed by the scheduling component 199 of the network entity 2002 of FIG. 20. In some aspects, the first message over the set of PRBs may span a first duration and retransmission of the first portion of the first message over the first subset of the PRB bundles spans a second duration that is shorter than the first duration. In some aspects, the first message may comprise a PUSCH message or a PUCCH message.

At 1916, the network entity obtains a first portion of the first message associated with a subset of one or more PRBs in the set of PRBs in a subsequent slot, the set of PRBs grouped into a set of PRB bundles including a first subset of PRB bundles corresponding to the subset of the one or more PRBs. The obtaining may be performed by the scheduling component 199 of the network entity 2002 of FIG. 20. In some aspects, the first message on the set of PRBs, at 1914, and the first portion of the first message on the subset of the one or more PRBs, at 1916 may have a same redundancy version (RV).

In some aspects, a retransmission of the first portion of the first message associated with the first subset of the PRB bundles, at 1718, may span multiple slots.

At 1904, the network entity may output first scheduling information for retransmission of the first message, at 1904, and output an indication of the first subset of the PRB bundles, at 1906. The output may be performed by the scheduling component 199 of the network entity 2002 of FIG. 20. The indication may include a bitmap indicating to retransmit or to skip retransmission of a respective portion of the first message associated with each PRB bundle in the set of PRB bundles, and the network entity may output a PRB bundle size indication that indicates a quantity of PRBs included in each PRB bundle of the set of PRB bundles, at 1908. The output may be performed by the scheduling component 199 of the network entity 2002 of FIG. 20. In some aspects, the first scheduling information and the indication of the first subset of the PRB bundles may be output, at 1904 and 1906, after the first message is obtained, at 1914.

As illustrated at 1902, the network entity may obtain, prior to obtaining the first message, an SRS or a second message on the set of PRBs. The obtaining may be performed by the scheduling component 199 of the network entity 2002 of FIG. 20. Then, at 1904, the network entity may output scheduling information for transmission of the first message spanning the set of PRB s, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one. The output may be performed by the scheduling component 199 of the network entity 2002 of FIG. 20. The network entity may identify the first message obtained, at 1914, spanning the set of PRBs as a first repetition of each PRB bundle of the set of PRB bundles. The identifying may be performed by the scheduling component 199 of the network entity 2002 of FIG. 20.

As illustrated at 1904, the network entity may output scheduling information for the first message, the scheduling information indicating a respective repetition factor for each PRB bundle of the first subset of the PRB bundles. The output may be performed by the scheduling component 199 of the network entity 2002 of FIG. 20.

As illustrated at 1908, the network entity may output a PRB bundle size indication that indicates a quantity of PRBs included in each PRB bundle of the set of PRB bundles, and 1912, may output information indicating one or more repetition factors, wherein each repetition factor of the one or more repetition factors is associated with a corresponding PRB bundle in the set of PRB bundles based on the PRB bundle size indication. The output may be performed by the scheduling component 199 of the network entity 2002 of FIG. 20.

As illustrated at 1910, the network entity may output an indication of a second frequency resource for the first portion of the first message that is different than a first frequency resource for the first message. The output may be performed by the scheduling component 199 of the network entity 2002 of FIG. 20.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the scheduling component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memories (e.g., the on-chip memory 2012′, the on-chip memory 2032′, and/or the on-chip memory 2042′) and/or the additional memory modules (e.g., the additional memory modules 2014, the additional memory modules 2034, and/or the additional memory modules 2044) may each be considered a computer-readable medium/memory. Each computer-readable medium/memory may be non-transitory. Each of the CU processor 2012, the DU processor 2032, the RU processor 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the scheduling component 199 is configured to obtain a first message spanning a set of physical resource blocks (PRBs) in a first slot; and obtain a first portion of the first message associated with a subset of one or more PRBs in the set of PRBs in a subsequent slot, the set of PRBs grouped into a set of PRB bundles including a first subset of PRB bundles corresponding to the subset of the one or more PRBs. The scheduling component 199 may be further configured to perform any of the aspects described in connection with FIG. 19A and/or FIG. 19B, or the aspects performed by the base station or network in any of FIG. 1, FIG. 3, FIG. 4, FIG. 10, FIG. 12, FIG. 14, or FIG. 15. The scheduling component 199 may be within one or more processors of one or more of the CU 2010, DU 2030, and the RU 2040. The scheduling component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1802 may include a variety of components configured for various functions. For example, the scheduling component 199 may include one or more hardware components that perform each of the blocks of the algorithm in the flowcharts of FIG. 19A and/or FIG. 19B, or the aspects performed by the base station or network in any 1, FIG. 3, FIG. 4, FIG. 10, FIG. 12, FIG. 14, or FIG. 15.

In one configuration, the network entity 1802 includes means for obtaining a first message spanning a set of physical resource blocks (PRBs) in a first slot; and means for obtaining a first portion of the first message associated with a subset of one or more PRBs in the set of PRBs in a subsequent slot, the set of PRBs grouped into a set of PRB bundles including a first subset of PRB bundles corresponding to the subset of the one or more PRBs. The apparatus may further include means for outputting first scheduling information for retransmission of the first message; and means for outputting an indication of the first subset of the PRB bundles, wherein the at least one processor is coupled to at least one antenna. The apparatus may further include means for outputting a PRB bundle size indication that indicates a quantity of PRB s included in each PRB bundle of the set of PRB bundles. The apparatus may further include means for obtaining, prior to obtaining the first message, a sounding reference signal (SRS) or a second message on the set of PRB s; means for outputting scheduling information for transmission of the first message spanning the set of PRBs, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one; and means for identifying the first message obtained spanning the set of PRBs as a first repetition of each PRB bundle of the set of PRB bundles. The apparatus may further include means for outputting scheduling information for the first message, the scheduling information indicating a respective repetition factor for each PRB bundle of the first subset of the PRB bundles. The apparatus may further include means for outputting a PRB bundle size indication that indicates a quantity of PRBs included in each PRB bundle of the set of PRB bundles; and means for outputting information indicating one or more repetition factors, wherein each repetition factor of the one or more repetition factors is associated with a corresponding PRB bundle in the set of PRB bundles based on the PRB bundle size indication. The apparatus may include means for outputting an indication of a second frequency resource for the first portion of the first message that is different than a first frequency resource for the first message. In one configuration, the network entity 1802 includes means for performing any of the aspects of the methods of FIG. 19A and/or FIG. 19B, or the aspects performed by the base station or network in any of 1, FIG. 3, FIG. 4, FIG. 10, FIG. 12, FIG. 14, or FIG. 15. The means may be the scheduling component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

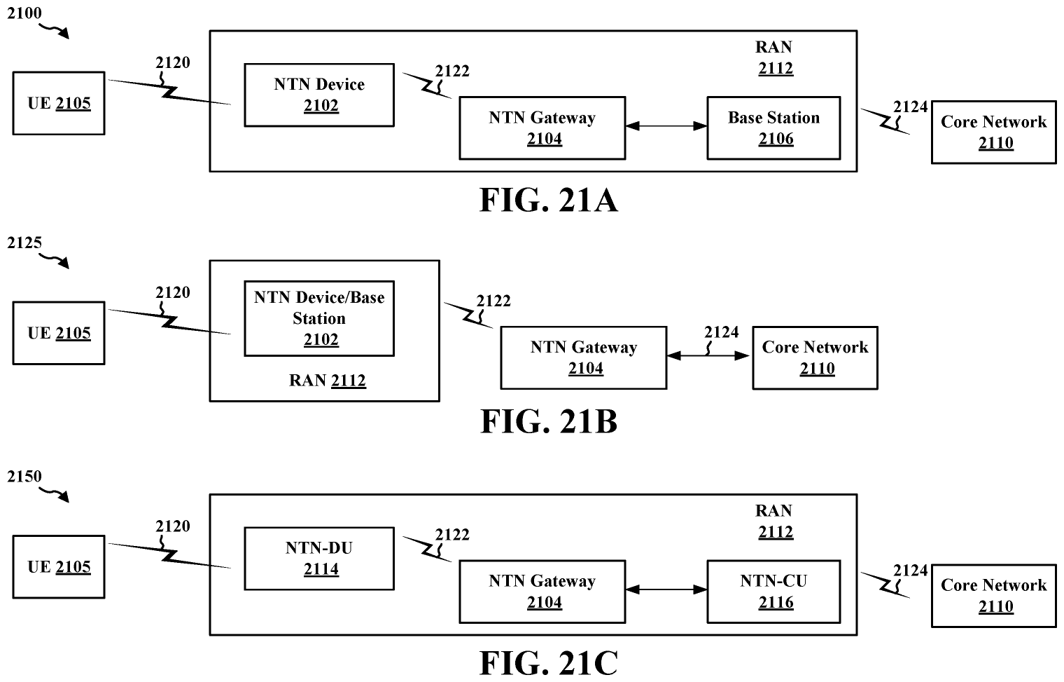

FIG. 21A provides a generalized illustration of various components, any or all of which may be utilized as appropriate, and each of which may be duplicated or omitted, as necessary. Specifically, although the example of FIG. 21A includes one UE 2105, it should be understood that many UEs (e.g., hundreds, thousands, millions, etc.) may utilize the network architecture 2100. Similarly, the network architecture 2100 may include a larger (or smaller) number of NTN devices, NTN gateways, base stations, RAN, core networks, and/or other components. The illustrated connections that connect the various components in the network architecture 2100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 2105 may be configured to communicate with the core network 2110 via the NTN device 2102, the NTN gateway 2104, and the base station 2106. As illustrated by the RAN 2112, one or more RANs associated with the core network 2110 may include one or more base stations. Access to the network may be provided to the UE 2105 via wireless communication between the UE 2105 and the base station 2106 (e.g., a serving base station), via the NTN device 2102 and the NTN gateway 2104. The base station 2106 may provide wireless communications access to the core network 2110 on behalf of the UE 2105, e.g., using 5G NR.

The base station 2106 may be referred to by other names such as a network entity, a gNB, a base station, a network node, a “satellite node”, a satellite NodeB (sNB), “satellite access node”, etc. The base station 2106 may not be the same as terrestrial network gNB s, but may be based on a terrestrial network gNB with additional capability. For example, the base station 2106 may terminate the radio interface and associated radio interface protocols to the UE 2105 and may transmit DL signals to the UE 2105 and receive UL signals from the UE 2105 via the NTN device 2102 and the NTN gateway 2104. The base station 2106 may also support signaling connections and voice and data bearers to the UE 2105 and may support handover of the UE 2105 between different radio cells for the NTN device 2102, between different NTN devices and/or between different base stations. The base station 2106 may be configured to manage moving radio beams (e.g., for airborne vehicles and/or non-geostationary (non-GEO) devices) and associated mobility of the UE 2105. The base station 2106 may assist in the handover (or transfer) of the NTN device 2102 between different NTN gateways or different base stations. In some examples, the base station 2106 may be separate from the NTN gateway 2104, e.g., as illustrated in the example of FIG. 21A. In other examples, the base station 2106 may include or may be combined with one or more NTN gateways, e.g., using a split architecture. For example, with a split architecture, the base station 2106 may include a Central Unit (CU), such as the example CU 110 of FIG. 1, and the NTN gateway 2104 may include or act as Distributed Unit (DU), such as the example DU 130 of FIG. 1. The base station 2106 may be fixed on the ground with transparent payload operation. In one implementation, the base station 2106 may be physically combined with, or physically connected to, the NTN gateway 2104 to reduce complexity and cost.

The NTN gateway 2104 may be shared by more than one base station and may communicate with the UE 2105 via the NTN device 2102. The NTN gateway 2104 may be dedicated to one associated constellation of NTN devices. The NTN gateway 2104 may be included within the base station 2106, e.g., as a base station-DU within the base station 2106. The NTN gateway 2104 may communicate with the NTN device 2102 using control and user plane protocols. The control and user plane protocols between the NTN gateway 2104 and the NTN device 2102 may: (i) establish and release the NTN gateway 2104 to the NTN device 2102 communication links, including authentication and ciphering; (ii) update NTN device software and firmware; (iii) perform NTN device Operations and Maintenance (O&M); (iv) control radio beams (e.g., direction, power, on/off status) and mapping between radio beams and NTN gateway UL and DL payload; and/or (v) assist with handoff of the NTN device 2102 or radio cell to another NTN gateway.

Support of transparent payloads with the network architecture 2100 shown in FIG. 21A may impact the communication system as follows. The core network 2110 may treat a satellite RAT as a new type of RAT with longer delay, reduced bandwidth and/or higher error rate. Consequently, there may be some impact to PDU session establishment and mobility management (MM) and connection management (CM) procedures. The NTN device 2102 may be shared with other services (e.g., satellite television, fixed Internet access) with 5G NR mobile access for UEs added in a transparent manner. This may enable legacy NTN devices to be used and may avoid the need to deploy a new type of NTN device. The base station 2106 may assist assignment and transfer of the NTN device 2102 and radio cells between the base station 2106 and the NTN gateway 2104 and support handover of the UE 2105 between radio cells, NTN devices, and other base stations. Thus, the base station 2106 may differ from a terrestrial network gNB. Additionally, a coverage area of the base station 2106 may be much larger than the coverage area of a terrestrial network base station.

In the illustrated example of FIG. 21A, a service link 2120 may facilitate communication between the UE 2105 and the NTN device 2102, a feeder link 2122 may facilitate communication between the NTN device 2102 and the NTN gateway 2104, and an interface 2124 may facilitate communication between the base station 2106 and the core network 2110. The service link 2120 and the feeder link 2122 may be implemented by a same radio interface (e.g., the NR-Uu interface). The interface 2124 may be implemented by the NG interface.

FIG. 21B shows a diagram of a network architecture 2125 capable of supporting NTN access, e.g., using 5G NR, as presented herein. The network architecture 2125 shown in FIG. 21B is similar to that shown in FIG. 21A, like designated elements being similar or the same. FIG. 21B, however, illustrates a network architecture with regenerative payloads, as opposed to transparent payloads shown in FIG. 21A. A regenerative payload, unlike a transparent payload, includes an on-board base station (e.g., includes the functional capability of a base station), and is referred to herein as an NTN device 2102/base station. The on-board base station may be a network node that corresponds to the base station 310 in FIG. 3. The RAN 2112 is illustrated as including the NTN device 2102/base station. Reference to the NTN device 2102/base station may refer to functions related to communication with the UE 2105 and the core network 2110 and/or to functions related to communication with the NTN gateway 2104 and with the UE 2105 at a physical radio frequency level.

An on-board base station may perform many of the same functions as the base station 2106 as described previously. For example, the NTN device 2102/base station may terminate the radio interface and associated radio interface protocols to the UE 2105 and may transmit DL signals to the UE 2105 and receive UL signals from the UE 2105, which may include encoding and modulation of transmitted signals and demodulation and decoding of received signals. The NTN device 2102/base station may also support signaling connections and voice and data bearers to the UE 2105 and may support handover of the UE 2105 between different radio cells for the NTN device 2102/base station and between or among different NTN device/base stations. The NTN device 2102/base station may assist in the handover (or transfer) of the UE 2105 between different NTN gateways and different control networks. The NTN device 2102/base station may hide or obscure specific aspects of the NTN device 2102/base station from the core network 2110, e.g., by interfacing to the core network 2110 in the same way or in a similar way to a terrestrial network base station. The NTN device 2102/base station may further assist in sharing of the NTN device 2102/base station. The NTN device 2102/base station may communicate with one or more NTN gateways and with one or more core networks via the NTN gateway 2104. In some aspects, the NTN device 2102/base station may communicate directly with other NTN device/base stations using Inter-Satellite Links (ISLs), which may support an Xn interface between any pair of NTN device/base stations.

With low Earth orbit (LEO) devices, the NTN device 2102/base station may manage moving radio cells with coverage at different times. The NTN gateway 2104 may be connected directly to the core network 2110, as illustrated. The NTN gateway 2104 may be shared by multiple core networks, for example, if NTN gateways are limited. In some examples the core network 2110 may need to be aware of coverage area(s) of the NTN device 2102/base station in order to page the UE 2105 and to manage handover. Thus, as can be seen, the network architecture 2125 with regenerative payloads may have more impact and complexity with respect to both the NTN device 2102/base station and the core network 2110 than the network architecture 2100 including transparent payloads, as shown in FIG. 21A.

Support of regenerative payloads with the network architecture 2125 shown in FIG. 21B may impact the network architecture 2125 as follows. The core network 2110 may be impacted if fixed tracking areas and fixed cells are not supported, because core components of mobility management and regulatory services, which are based on fixed cells and fixed tracking areas for terrestrial PLMNs, may be replaced by a new system (e.g., based on a location of the UE 2105). If fixed tracking areas and fixed cells are supported, the core network 2110 may map any fixed tracking area to one or more NTN device/base stations with current radio coverage of the fixed tracking area when performing paging of the UE 2105 that is located in this fixed tracking area. This could include configuration in the core network 2110 of long term orbital data for the NTN device 2102/base station (e.g., obtained from an operator of the NTN device 2102/base station) and could add significant new impact to core network 2110.

In the illustrated example of FIG. 21B, a service link 2120 may facilitate communication between the UE 2105 and the NTN device 2102/base station, a feeder link 2122 may facilitate communication between the NTN device 2102/base station and the NTN gateway 2104, and an interface 2124 may facilitate communication between the NTN gateway 2104 and the core network 2110. The service link 2120 may be implemented by the NR-Uu interface. The feeder link 2122 may be implemented by the NG interface over SRI. The interface 2124 may be implemented by the NG interface.

FIG. 21C shows a diagram of a network architecture 2150 capable of supporting NTN access, e.g., using 5G NR, as presented herein. The network architecture shown in FIG. 21C is similar to that shown in FIG. 21A and FIG. 21B, like designated elements being similar or the same. FIG. 21C, however, illustrates a network architecture with regenerative payloads, as opposed to transparent payloads, as shown in FIG. 21A, and with a split architecture for the base station. For example, the base station may be split between a Central Unit (CU), such as the CU 110 of FIG. 1, and a Distributed Unit (DU), such as the DU 130 of FIG. 1. In the illustrated example of FIG. 21C, the network architecture 2150 includes an NTN-CU 2116, which may be a ground-based base station or a terrestrial base station. The regenerative payloads include an on-board base station DU, and is referred to herein as an NTN-DU 2114. The NTN-CU 2116 and the NTN-DU 2114, collectively or individually, may correspond to the network node associated with the base station 310 in FIG. 3.

The NTN-DU 2114 communicates with the NTN-CU 2116 via the NTN gateway 2104. The NTN-CU 2116 together with the NTN-DU 2114 perform functions, and may use internal communication protocols, which are similar to or the same as a gNB with a split architecture. In the example, the NTN-DU 2114 may correspond to and perform functions similar to or the same as a gNB Distributed Unit (gNB-DU), while the NTN-CU 2116 may correspond to and perform functions similar to or the same as a gNB Central Unit (gNB-CU). However, the NTN-CU 2116 and the NTN-DU 2114 may each include additional capability to support the UE 2105 access using NTN devices.

The NTN-DU 2114 and the NTN-CU 2116 may communicate with one another using an F1 Application Protocol (F1AP), and together may perform some or all of the same functions as the base station 2106 or the NTN device 2102/base station as described in connection with FIG. 21B and FIG. 21C, respectively.

The NTN-DU 2114 may terminate the radio interface and associated lower level radio interface protocols to the UE 2105 and may transmit DL signals to the UE 2105 and receive UL signals from the UE 2105, which may include encoding and modulation of transmitted signals and demodulation and decoding of received signals. The operation of the NTN-DU 2114 may be partly controlled by the NTN-CU 2116. The NTN-DU 2114 may support one or more NR radio cells for the UE 2105. The NTN-CU 2116 may also be split into separate control plane (CP) (NTN-CU-CP) and user plane (UP) (NTN-CU-UP) portions. The NTN-DU 2114 and the NTN-CU 2116 may communicate over an F1 interface to (a) support control plane signaling for the UE 2105 using IP, Stream Control Transmission Protocol (SCTP) and F1 Application Protocol (F1AP) protocols, and (b) to support user plane data transfer for a UE using IP, User Datagram Protocol (UDP), PDCP, SDAP, GTP-U and NR User Plane Protocol (NRUPP) protocols.

The NTN-CU 2116 may communicate with one or more other NTN-CUs and/or with one more other terrestrial base stations using terrestrial links to support an Xn interface between any pair of NTN-CUs and/or between the NTN-CU 2116 and any terrestrial base station.

The NTN-DU 2114 together with the NTN-CU 2116 may: (i) support signaling connections and voice and data bearers to the UE 2105; (ii) support handover of the UE 2105 between different radio cells for the NTN-DU 2114 and between different NTN-DUs; and (iii) assist in the handover (or transfer) of NTN devices between different NTN gateways or different core networks. The NTN-CU 2116 may hide or obscure specific aspects of the NTN devices from the core network 2110, e.g., by interfacing to the core network 2110 in the same way or in a similar way to a terrestrial network base station.

In the network architecture 2150 of FIG. 21C, the NTN-DU 2114 that communicates with and is accessible from an NTN-CU may change over time with LEO devices. With the split base station architecture, the core network 2110 may connect to NTN-CUs that are fixed and that do not change over time, which may reduce difficulty with paging of the UE 2105. For example, the core network 2110 may not need to know which NTN-DU is needed for paging the UE 2105. The network architecture with regenerative payloads with a split base station architecture may thereby reduce the core network 2110 impact at the expense of additional impact to the NTN-CU 2116.

Support of regenerative payloads with a split base station architecture, as shown in FIG. 21C, may impact the network architecture 2150 as follows. The impact to the core network 2110 may be limited as for the transparent payloads (e.g., the NTN device 2102) discussed above. For example, the core network 2110 may treat a satellite RAT in the network architecture 2150 as a new type of RAT with longer delay, reduced bandwidth and/or higher error rate. The impact on the NTN-DU 2114 may be less than the impact on NTN device/base stations (e.g., the NTN device 2102/base station with a non-split architecture), as discussed above in reference to FIG. 21B. The NTN-DU 2114 may manage changing association with different (fixed) NTN-CUs. Further, the NTN-DU 2114 may manage radio beams and radio cells. The NTN-CU 2116 impacts may be similar to the impact of the base station 2106 for a network architecture with transparent payloads, as discussed above, except for extra impacts to manage changing associations with different NTN-DUs and reduced impacts to support radio cells and radio beams, which may be transferred to the NTN-DU 2114. In some aspects, the NTN device may correspond to a high altitude platform system (HAPS) that serves one or more UEs on the ground.

One or more satellites may be integrated with the terrestrial infrastructure of a wireless communication system. Satellites may refer to Low Earth Orbit (LEO) devices, Medium Earth Orbit (MEO) devices, Geostationary Earth Orbit (GEO) devices, and/or Highly Elliptical Orbit (HEO) devices. A non-terrestrial network (NTN) may refer to a network, or a segment of a network, that uses an airborne or spaceborne vehicle for transmission. An airborne vehicle may refer to High Altitude Platforms (HAPs) including Unmanned Aircraft Systems (UAS).

An NTN may be configured to help to provide wireless communication in un-served or underserved areas to upgrade the performance of terrestrial networks. For example, a communication satellite may provide coverage to a larger geographic region than a TN base station. The NTN may also reinforce service reliability by providing service continuity for UEs or for moving platforms (e.g., passenger vehicles-aircraft, ships, high speed trains, buses). The NTN may also increase service availability, including critical communications. The NTN may also enable network scalability through the provision of efficient multicast/broadcast resources for data delivery towards the network edges or even directly to the user equipment.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication, comprising: transmitting a first message spanning a set of physical resource blocks (PRBs); retransmitting a first portion of the first message associated with a first subset of one or more PRBs in the set of PRBs, the set of PRBs grouped into a set of PRB bundles including a first subset of PRB bundles corresponding to the first subset of the one or more PRBs; and skipping retransmission of a second portion of the first message associated with a second subset of the PRB bundles of the set of PRB bundles, the second subset of the PRB bundles corresponding to at least a portion of remaining PRBs in the set of PRBs.

Aspect 2 is the method of aspect 1, further including: receiving first scheduling information for retransmission of the first message; and receiving an indication of the first subset of the PRB bundles.

Aspect 3 is the method of any of aspects 1 and 2, further including that the indication comprises a bitmap indicating to retransmit or to skip the retransmission of a respective portion of the first message associated with each PRB bundle in the set of PRB bundles.

Aspect 4 is the method of any of aspects 1 to 3, further including: receiving a PRB bundle size indication that indicates a quantity of PRBs included in each PRB bundle of the set of PRB bundles.

Aspect 5 is the method of any of aspects 1 to 4, further including: transmitting a second message spanning a second set of PRBs; receiving second scheduling information for a second message retransmission, the second scheduling information excluding at least one of a PRB bundle subset indication associated with the second set of PRBs or excluding a PRB bundle size indication; and retransmitting the second message on the second set of PRBs in response to the second scheduling information.

Aspect 6 is the method of any of aspects 1 to 5, further including that the first scheduling information and the indication of the first subset of the PRB bundles are received after transmission of the first message.

Aspect 7 is the method of any of aspects 1 to 6, further including that the first message on the set of PRBs and a retransmission of the first portion associated with the first subset of the one or more PRBs have a same redundancy version (RV).

Aspect 8 is the method of any of aspects 1 to 7, further including: generating a retransmission of the first message based on a same rate matching as the first message spanning the set of PRBs; and puncturing the retransmission in one or more remaining PRBs associated with the second subset of the PRB bundles.

Aspect 9 is the method of any of aspects 1 to 8, further including: transmitting, prior to transmission of the first message, a sounding reference signal (SRS) or a second message on the set of PRBs; and receiving scheduling information for the transmission of the first message spanning the set of PRB s, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one, and wherein the transmission of the first message spanning the set of PRBs corresponds to a first repetition of each PRB bundle of the set of PRB bundles.

Aspect 10 is the method of any of aspects 1 to 9, further including: receiving scheduling information for the first message, the scheduling information indicating a respective repetition factor for each PRB bundle of the first subset of the PRB bundles.

Aspect 11 is the method of any of aspects 1 to 10, further including: receiving a PRB bundle size indication that indicates a quantity of PRBs included in each PRB bundle of the set of PRB bundles; and receiving information indicating one or more repetition factors, wherein each repetition factor of the one or more repetition factors is associated with a corresponding PRB bundle in the set of PRB bundles based on the PRB bundle size indication.

Aspect 12 is the method of any of aspects 1 to 11, further including: receiving an indication of a second frequency resource for a retransmission of the first portion of the first message that is different than a first frequency resource for the first message.

Aspect 13 is the method of any of aspects 1 to 12, further including that a retransmission of the first portion of the first message associated with the first subset of the PRB bundles spans multiple slots.

Aspect 14 is the method of any of aspects 1 to 13, further including that the first message over the set of PRBs spans a first duration and retransmission of the first portion of the first message over the first subset of the PRB bundles spans a second duration that is shorter than the first duration.

Aspect 15 is the method of any of aspects 1 to 14, further including that the first message comprises a physical uplink shared channel (PUSCH) message or a physical uplink control channel (PUCCH) message.

Aspect 16 is an apparatus for wireless communication including at least one processor coupled to a memory and configured to implement any of aspects 1 to 15.

In aspect 17, the apparatus of aspect 16 further includes at least one antenna coupled to the at least one processor.

In aspect 18, the apparatus of aspect 16 or 17 further includes a transceiver coupled to the at least one processor.

Aspect 19 is an apparatus for wireless communication including means for implementing any of aspects 1 to 15.

In aspect 20, the apparatus of aspect 19 further includes at least one antenna coupled to the means to perform the method of any of aspects 1 to 15.

In aspect 21, the apparatus of aspect 19 or 20 further includes a transceiver coupled to the means to perform the method of any of aspects 1 to 15.

Aspect 22 is a non-transitory computer-readable storage medium storing computer executable code, where the code, when executed, causes a processor to implement any of aspects 1 to 15.

Aspect 23 is a method of wireless communication, comprising: obtaining a first message spanning a set of physical resource blocks (PRBs) in a first slot; and obtaining a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

Aspect 24 is the method of aspect 23, further including: outputting first scheduling information for retransmission of the first message; and outputting an indication of the first subset of the PRB bundles, wherein the at least one processor is coupled to at least one antenna.

Aspect 25 is the method of any of aspects 23 and 24, further including that the indication comprises a bitmap indicating to retransmit or to skip retransmission of a respective portion of the first message associated with each PRB bundle in the set of PRB bundles, and the method further includes: outputting a PRB bundle size indication that indicates a quantity of PRBs included in each PRB bundle of the set of PRB bundles.

Aspect 26 is the method of any of aspects 23 to 25, further including that the first scheduling information and the indication of the first subset of the PRB bundles are outputted after the first message is obtained.

Aspect 27 is the method of any of aspects 23 to 26, further including that the first message on the set of PRBs and the first portion of the first message on the subset of the one or more PRBs have a same redundancy version (RV).

Aspect 28 is the method of any of aspects 23 to 27, further including: obtaining, prior to obtaining the first message, a sounding reference signal (SRS) or a second message on the set of PRBs; outputting scheduling information for transmission of the first message spanning the set of PRBs, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one; and identifying the first message obtained spanning the set of PRBs as a first repetition of each PRB bundle of the set of PRB bundles.

Aspect 29 is the method of any of aspects 23 to 28, further including: outputting scheduling information for the first message, the scheduling information indicating a respective repetition factor for each PRB bundle of the first subset of the PRB bundles.

Aspect 30 is the method of any of aspects 23 to 29, further including: outputting a PRB bundle size indication that indicates a quantity of PRBs included in each PRB bundle of the set of PRB bundles; and outputting information indicating one or more repetition factors, wherein each repetition factor of the one or more repetition factors is associated with a corresponding PRB bundle in the set of PRB bundles based on the PRB bundle size indication.

Aspect 31 is the method of any of aspects 23 to 30, further including: outputting an indication of a second frequency resource for the first portion of the first message that is different than a first frequency resource for the first message.

Aspect 32 is the method of any of aspects 23 to 31, further including that the subsequent slot associated with the first portion of the first message spans multiple slots.

Aspect 33 is the method of any of aspects 23 to 32, further including that the first message over the set of PRBs spans a first duration and the first portion of the first message on the first subset of the PRB bundles spans a second duration that is shorter than the first duration.

Aspect 34 is the method of any of aspects 23 to 33, further including that the first message comprises a physical uplink shared channel (PUSCH) message or a physical uplink control channel (PUCCH) message.

Aspect 35 is an apparatus for wireless communication including at least one processor coupled to a memory and configured to implement any of aspects 23 to 34.

In aspect 36, the apparatus of aspect 35 further includes at least one antenna coupled to the at least one processor.

In aspect 37, the apparatus of aspect 35 or 36 further includes a transceiver coupled to the at least one processor.

Aspect 38 is an apparatus for wireless communication including means for implementing any of aspects 23 to 34.

In aspect 39, the apparatus of aspect 38 further includes at least one antenna coupled to the means to perform the method of any of aspects 23 to 34.

In aspect 40, the apparatus of aspect 38 or 39 further includes a transceiver coupled to the means to perform the method of any of aspects 23 to 34.

Aspect 41 is a non-transitory computer-readable storage medium storing computer executable code, where the code, when executed, causes a processor to implement any of aspects 23 to 34.

What is claimed is:

1. An apparatus for wireless communication, comprising:
a memory; and
at least one processor coupled to the memory and configured to:
transmit a first message spanning a set of physical resource blocks (PRBs);
retransmit a first portion of the first message associated with a first subset of one or more PRBs in the set of PRBs, the set of PRBs grouped into a set of PRB bundles including a first subset of PRB bundles corresponding to the first subset of the one or more PRBs; and
skip retransmission of a second portion of the first message associated with a second subset of the PRB bundles of the set of PRB bundles, the second subset of the PRB bundles corresponding to at least a portion of remaining PRBs in the set of PRBs.

2. The apparatus of claim 1, wherein the at least one processor is further configured to:
receive first scheduling information for retransmission of the first message; and
receive an indication of the first subset of the PRB bundles.

3. The apparatus of claim 2, wherein the indication comprises a bitmap indicating to retransmit or to skip the retransmission of a respective portion of the first message associated with each PRB bundle in the set of PRB bundles.

4. The apparatus of claim 3, wherein the at least one processor is further configured to:
receive a PRB bundle size indication that indicates a quantity of PRBs included in each PRB bundle of the set of PRB bundles.

5. The apparatus of claim 2, wherein the at least one processor is further configured to:
transmit a second message spanning a second set of PRBs;
receive second scheduling information for a second message retransmission, the second scheduling information excluding at least one of a PRB bundle subset indication associated with the second set of PRBs or excluding a PRB bundle size indication; and
retransmit the second message on the second set of PRBs in response to the second scheduling information.

6. The apparatus of claim 2, wherein the first scheduling information and the indication of the first subset of the PRB bundles are received after transmission of the first message.

7. The apparatus of claim 1, wherein the first message on the set of PRBs and a retransmission of the first portion associated with the first subset of the one or more PRBs have a same redundancy version (RV).

8. The apparatus of claim 1, wherein the at least one processor is further configured to:
generate a retransmission of the first message based on a same rate matching as the first message spanning the set of PRBs; and
puncture the retransmission in one or more remaining PRBs associated with the second subset of the PRB bundles.

9. The apparatus of claim 1, wherein the at least one processor is further configured to:
transmit, prior to transmission of the first message, a sounding reference signal (SRS) or a second message on the set of PRBs; and
receive scheduling information for the transmission of the first message spanning the set of PRBs, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one, and wherein the transmission of the first message spanning the set of PRBs corresponds to a first repetition of each PRB bundle of the set of PRB bundles.

10. The apparatus of claim 1, wherein the at least one processor is further configured to:
receive scheduling information for the first message, the scheduling information indicating a respective repetition factor for each PRB bundle of the first subset of the PRB bundles.

11. The apparatus of claim 10, wherein the at least one processor is further configured to:
receive a PRB bundle size indication that indicates a quantity of PRBs included in each PRB bundle of the set of PRB bundles; and
receive information indicating one or more repetition factors, wherein each repetition factor of the one or more repetition factors is associated with a corresponding PRB bundle in the set of PRB bundles based on the PRB bundle size indication.

12. The apparatus of claim 1, wherein the at least one processor is further configured to:
receive an indication of a second frequency resource for a retransmission of the first portion of the first message that is different than a first frequency resource for the first message.

13. The apparatus of claim 1, wherein a retransmission of the first portion of the first message associated with the first subset of the PRB bundles spans multiple slots.

14. The apparatus of claim 1, wherein the first message over the set of PRBs spans a first duration and retransmission of the first portion of the first message over the first subset of the PRB bundles spans a second duration that is shorter than the first duration.

15. The apparatus of claim 1, wherein the first message comprises a physical uplink shared channel (PUSCH) message or a physical uplink control channel (PUCCH) message.

16. The apparatus of claim 1, further comprising at least one antenna coupled to the at least one processor.

17. A method of wireless communication, comprising:
transmitting a first message spanning a set of physical resource blocks (PRBs);
retransmitting a first portion of the first message associated with a first subset of one or more PRBs in the set of PRBs, the set of PRBs grouped into a set of PRB bundles including a first subset of PRB bundles corresponding to the first subset of the one or more PRBs; and
skipping retransmission of a second portion of the first message associated with a second subset of the PRB bundles of the set of PRB bundles, the second subset of the PRB bundles corresponding to at least a portion of remaining PRBs in the set of PRBs.

18. An apparatus for wireless communication, comprising:
a memory; and
at least one processor coupled to the memory and configured to:
obtain a first message spanning a set of physical resource blocks (PRBs) in a first slot; and
obtain a first portion of the first message associated with a subset of one or more PRBs in the set of PRBs in a subsequent slot, the set of PRBs grouped into a set of PRB bundles including a first subset of PRB bundles corresponding to the subset of the one or more PRBs.

19. The apparatus of claim 18, wherein the at least one processor is further configured to:
output first scheduling information for retransmission of the first message; and
output an indication of the first subset of the PRB bundles,
wherein the at least one processor is coupled to at least one antenna.

20. The apparatus of claim 19, wherein the indication comprises a bitmap indicating to retransmit or to skip retransmission of a respective portion of the first message associated with each PRB bundle in the set of PRB bundles, and the at least one processor is further configured to:
output a PRB bundle size indication that indicates a quantity of PRBs included in each PRB bundle of the set of PRB bundles.

21. The apparatus of claim 19, wherein the first scheduling information and the indication of the first subset of the PRB bundles are outputted after the first message is obtained.

22. The apparatus of claim 18, wherein the first message on the set of PRBs and the first portion of the first message on the subset of the one or more PRBs have a same redundancy version (RV).

23. The apparatus of claim 18, wherein the at least one processor is further configured to:
obtain, prior to obtaining the first message, a sounding reference signal (SRS) or a second message on the set of PRBs;
output scheduling information for transmission of the first message spanning the set of PRBs, the scheduling information including a PRB bundle size indication that indicates a quantity of PRBs included in each PRB bundle of the set of PRB bundles, and a respective repetition factor for each PRB bundle of the set of PRB bundles, the respective repetition factor for each PRB bundle of the first subset of the PRB bundles being greater than one; and
identify the first message obtained spanning the set of PRBs as a first repetition of each PRB bundle of the set of PRB bundles.

24. The apparatus of claim 18, wherein the at least one processor is further configured to:
output scheduling information for the first message, the scheduling information indicating a respective repetition factor for each PRB bundle of the first subset of the PRB bundles.

25. The apparatus of claim 24, wherein the at least one processor is further configured to:
output a PRB bundle size indication that indicates a quantity of PRBs included in each PRB bundle of the set of PRB bundles; and
output information indicating one or more repetition factors, wherein each repetition factor of the one or more repetition factors is associated with a corresponding PRB bundle in the set of PRB bundles based on the PRB bundle size indication.

26. The apparatus of claim 18, wherein the at least one processor is further configured to:
output an indication of a second frequency resource for the first portion of the first message that is different than a first frequency resource for the first message.

27. The apparatus of claim 18, wherein the subsequent slot associated with the first portion of the first message spans multiple slots.

28. The apparatus of claim 18, wherein the first message over the set of PRBs spans a first duration and the first portion of the first message on the first subset of the PRB bundles spans a second duration that is shorter than the first duration.

29. The apparatus of claim 18, wherein the first message comprises a physical uplink shared channel (PUSCH) message or a physical uplink control channel (PUCCH) message.

30. A method of wireless communication, comprising:
obtaining a first message spanning a set of physical resource blocks (PRBs) in a first slot; and
obtaining a first portion of the first message associated with a subset of one or more PRBs in the set of PRBs in a subsequent slot, the set of PRBs grouped into a set of PRB bundles including a first subset of PRB bundles corresponding to the subset of the one or more PRBs.
